(19) United States
(12) Patent Application Publication
(10) Pub. No.: US 2012/0140886 A1
(43) Pub. Date: Jun. 7, 2012

(54) RADIOGRAPHIC PHASE-CONTRAST IMAGING METHOD AND APPARATUS

(75) Inventors: Dai MURAKOSHI, Ashigarakami-gun (JP); Naoto IWAKIRI, Ashigarakami-gun (JP)

(73) Assignee: FUJIFILM CORPORATION, Tokyo (JP)

(21) Appl. No.: 13/311,990

(22) Filed: Dec. 6, 2011

(30) Foreign Application Priority Data
Dec. 7, 2010 (JP) 2010-272188
Dec. 5, 2011 (JP) 2011-266019

(51) Int. Cl. G01N 23/04

(52) U.S. Cl. 378/62

(57) ABSTRACT

A radiographic phase-contrast imaging apparatus includes: a first grating having a periodically-arranged grating structure and allowing radiation emitted from a radiation source to pass therethrough to form a first periodic-pattern image; a second grating having a periodically-arranged grating structure including areas transmitting the first periodic-pattern image and areas shielding the first periodic-pattern image to form a second periodic-pattern image; a radiographic image detector to detect the second periodic-pattern image; a moving mechanism to effect relative movement of the radiographic image detector toward and away from the radiation source, thereby achieving magnification imaging; and an acceptable magnification factor calculation unit to calculate an acceptable magnification factor based on size information of the radiographic image detector and size information of at least one of the first and second gratings, the acceptable magnification factor ensuring the radiation transmitted through the first and second gratings to be received within the radiographic image detector.

### BACKGROUND OF THE INVENTION

1. Field of the Invention

The present invention relates to radiographic phase-contrast imaging method and apparatus using gratings, and, in particular, to radiographic phase-contrast imaging method and apparatus for carrying out magnification imaging.

2. Description of the Related Art

X-rays have a nature that they attenuate depending on the atomic number of an element forming a substance and the density and thickness of the substance. Because of this nature, X-rays are used as a probe to investigate the interior of a subject. Imaging systems using X-rays have widely been used in the fields of medical diagnosis, nondestructive testing, etc.

With a typical X-ray imaging system, a subject is placed between an X-ray source, which emits an X-ray, and an X-ray image detector, which detects an X-ray image, to take a transmission image of the subject. In this case, each X-ray emitted from the X-ray source toward the X-ray image detector attenuates (is absorbed) by an amount depending on a difference of characteristics (such as the atomic number, density and thickness) of substances forming the subject present in the path from the X-ray source to the X-ray image detector before the X-ray enters the X-ray image detector. As a result, an X-ray transmission image of the subject is detected and imaged by the X-ray image detector. As examples of such an X-ray image detector, a combination of an X-ray intensifying screen and a film, a photostimulable phosphor, and a flat panel detector (FPD) using a semiconductor circuit are widely used.

However, the smaller the atomic number of an element forming a substance, the lower the X-ray absorbing capability of the substance. Therefore, there is only a small difference of the X-ray absorbing capability between soft biological tissues or soft materials, and it is difficult to obtain a sufficient contrast of an image as the X-ray transmission image. For example, articular cartilages forming a joint of a human body and synovial fluids around the cartilages are composed mostly of water, and there is only a small difference of the X-ray absorption therebetween. It is therefore difficult to obtain an image with sufficient contrast.

In recent years, X-ray phase-contrast imaging for obtaining a phase contrast image based on phase variation of X-rays due to differences between refractive indexes of a subject, in place of the intensity variation of X-rays due to differences between absorption coefficients of a subject, have been studied. With this X-ray phase-contrast imaging using the phase difference, a high contrast image can be obtained even in the case where a subject is a substance having low X-ray absorbing capability.

As an example of such X-ray phase-contrast imaging systems, an X-ray phase-contrast imaging apparatus has been proposed, wherein two gratings including a first grating and a second grating are arranged parallel to each other at a predetermined interval, a self image of the first grating is formed at a position of the second grating based on the Talbot interference effect by the first grating, and the intensity of the self image of the first grating is modulated with the second grating to provide an X-ray phase contrast image.

On the other hand, with respect to typical X-ray imaging systems, various types of X-ray imaging cassettes, which have an X-ray image detector and other components contained in a compact housing, have been proposed. Such X-ray imaging cassettes are relatively thin and of a portable size, and thus are convenient for handling. Further, the X-ray imaging cassettes having various sizes and shapes are available depending on the size and type of a subject, and the X-ray imaging cassettes are adapted to be removably mounted on the imaging apparatus depending on conditions of the subject. Therefore, it is considered to use such cassettes with the above-described X-ray phase-contrast imaging apparatus.

In addition, the first and second gratings for use with the X-ray phase-contrast imaging apparatuses are also available in various sizes depending on the size of a subject, etc. Therefore, it is also considered to provide the first and second gratings which are adapted to be removably mounted on the apparatus so that they can be replaced depending on the use, similarly to the X-ray image detectors.

Still further, so-called magnification imaging, which is achieved by projecting a magnified X-ray image of a subject onto an X-ray image detector with adjusting the distance between the subject and the X-ray image detector, have conventionally been proposed.

Considering the case where the X-ray imaging cassettes, as described above, are used to carry out the magnification imaging, there may be the case where part of the radiation transmitted through the first and second gratings is not received within the detection plane of the X-ray image detector in the cassette, depending on the size of the cassette used and the ratio between a distance from the focal spot of the X-ray to the first and second gratings and a distance from the focal spot of the X-ray to the cassette.

Similarly, in the case where the first and second gratings are adapted to be removable, there may be the case where part of the radiation transmitted through the first and second gratings is not received within the detection plane of the X-ray image detector in the cassette, depending on the size of the first and second gratings used and the ratio between the distance from the focal spot of the X-ray to the first and second gratings and the distance from the focal spot of the X-ray to the cassette.

As described above, in the case where part of the radiation transmitted through the first and second gratings is not received within the detection plane of the X-ray image detector, the resulting X-ray image does not contain the entire range of the subject intended to be imaged. Thus, it is impossible to diagnose the missing part, and the subject is exposed to extra radiation at the missing part of the image. For example, in the case of mammography, imaging is carried out with the X-ray image detector being typically abutted on the chest wall. Therefore, when the magnification imaging is carried out, part of the image on the nipple side is out of the detection plane, and the resulting imaged range is insufficient for close examination.

Japanese Unexamined Patent Publication No. 2007-205208 (hereinafter, Patent Document 1) proposes an imaging apparatus for taking a phase contrast image, where the size of the radiographic image detector is obtained, and an acceptable range of the magnification factor is calculated depending on the size. However, the apparatus disclosed in Patent Document 1 is not of the above-described type using the first and second gratings, and Patent Document 1 proposes nothing about calculating an acceptable range of the magnification factor such that the radiation transmitted through such gratings is received within the detection plane of the radiographic image detector.

WO 2008/102598 (hereinafter, Patent Document 2) proposes an apparatus that carries out imaging with switching among three systems including a Talbot interferometry system, a Talbot-Lau interferometry system and a refraction contrast system, wherein the magnification factor is changed by moving a subject table in the vertical direction. However, Patent Document 2 proposes nothing about calculating an acceptable range of the magnification factor such that the radiation transmitted through the gratings is received within the detection plane of the radiographic image detector.

### SUMMARY OF THE INVENTION

In view of the above-described circumstances, the present invention is directed to providing radiographic phase-contrast imaging method and apparatus using two gratings which prevent such a situation that part of radiation transmitted through the two gratings is out of the detection plane of the radiographic image detector and is not received within the detection plane.

An aspect of the radiographic phase-contrast imaging method of the invention is a radiographic phase-contrast imaging method for use with a radiographic phase-contrast imaging apparatus including: a first grating having a periodically arranged grating structure and allowing radiation emitted from a radiation source to pass therethrough to form a first periodic pattern image; a second grating having a periodically arranged grating structure including areas transmitting the first periodic pattern image formed by the first grating and areas shielding the first periodic pattern image to form a second periodic pattern image; a radiographic image detector to detect the second periodic pattern image formed by the second grating; and a moving mechanism to move the radiographic image detector in directions of relative movement toward and away from the radiation source, thereby achieving magnification imaging, the method including: calculating an acceptable magnification factor based on size information of the radiographic image detector and size information of at least one of the first and second gratings, the acceptable magnification factor ensuring the radiation transmitted through the first and second gratings to be received within the radiographic image detector.

An aspect of the radiographic phase-contrast imaging apparatus of the invention is a radiographic phase-contrast imaging apparatus including: a first grating having a periodically arranged grating structure and allowing radiation emitted from a radiation source to pass therethrough to form a first periodic pattern image; a second grating having a periodically arranged grating structure including areas transmitting the first periodic pattern image formed by the first grating and areas shielding the first periodic pattern image to form a second periodic pattern image; a radiographic image detector to detect the second periodic pattern image formed by the second grating; a moving mechanism to move the radiographic image detector in directions of relative movement toward and away from the radiation source, thereby achieving magnification imaging; and an acceptable magnification factor calculation unit to calculate an acceptable magnification factor based on size information of the radiographic image detector and size information of at least one of the first and second gratings, the acceptable magnification factor ensuring the radiation transmitted through the first and second gratings to be received within the radiographic image detector.

In the radiographic phase-contrast imaging apparatus of the invention, the radiographic image detector may be replaceable.

The apparatus may further include a detector size information obtaining unit to obtain the size information of the radiographic image detector, wherein the acceptable magnification factor calculation unit calculates the acceptable magnification factor based on the size information obtained by the detector size information obtaining unit.

The apparatus may further include a magnification factor obtaining unit to receive and obtain an input of a magnification factor for the magnification imaging, wherein the moving mechanism moves the radiographic image detector according to the magnification factor obtained by the magnification factor obtaining unit.

The apparatus may further include a moving mechanism control unit to control the moving mechanism to move the radiographic image detector by a distance according to the magnification factor obtained by the magnification factor obtaining unit only in a case where the magnification factor is within a range of the acceptable magnification factor.

The apparatus may further include an imaging control unit to permit the magnification imaging to be carried out according to the magnification factor obtained by the magnification factor obtaining unit only in a case where the magnification factor is within a range of the acceptable magnification factor.

At least one of the first and second gratings may be replaceable.

The apparatus may further include a grid size obtaining unit to obtain the size information of at least one of the first and second gratings, wherein the acceptable magnification factor calculation unit calculates the acceptable magnification factor based on the size information of at least one of the first and second gratings obtained by the grid size obtaining unit and the size information of the radiographic image detector.

The apparatus may further include a magnification factor warning unit to warn, if the magnification factor obtained by the magnification factor obtaining unit is greater than the acceptable magnification factor, to that effect.

The apparatus may further include an acceptable magnification factor output unit to output the acceptable magnification factor.

The apparatus may further include: a radiation field diaphragm to confine an exposure range of the radiation emitted from the radiation source, the radiation field diaphragm being disposed between the radiation source and the first grating; and an acceptable radiation field size calculation unit to calculate an acceptable radiation field size of the radiation field diaphragm based on the acceptable magnification factor.

The apparatus may further include: a radiation field size obtaining unit to receive and obtain an input of a radiation field size of the radiation field diaphragm; and a radiation field size warning unit to warn, if the radiation field size obtained by the radiation field size obtaining unit is greater than the acceptable radiation field size, to that effect.

The apparatus may further include an acceptable radiation field size output unit to output the acceptable radiation field size.

The apparatus may further include a radiation field size limiter unit to limit a settable radiation field size of the radiation field diaphragm based on the acceptable radiation field size.

The apparatus may further include a radiation field diaphragm to confine an exposure range of the radiation emitted from the radiation source, the radiation field diaphragm being disposed between the radiation source and the first grating; and an acceptable magnification factor candidate obtaining unit to obtain, as a first acceptable magnification factor candidate, the acceptable magnification factor calculated based on the size information of the radiographic image detector and the size information of the first and second gratings, and to calculate a second acceptable magnification factor candidate based on the size information of the radiographic image detector and the radiation field size of the radiation field diaphragm.

The apparatus may further include a radiation field size obtaining unit to receive and obtain an input of the radiation field size of the radiation field diaphragm.

The apparatus may further include a radiation field size obtaining unit to obtain the radiation field size of the radiation field diaphragm based on a range set on an image obtained in advance.

The acceptable magnification factor calculation unit may compare the first acceptable magnification factor candidate with the second acceptable magnification factor candidate and may determine larger one of the acceptable magnification factor candidates as a final acceptable magnification factor.

The moving mechanism control unit may control the moving mechanism to move the radiographic image detector by a distance according to an inputted magnification factor only in a case where the inputted magnification factor is within a range of the final acceptable magnification factor.

The apparatus may further include an imaging control unit to permit the magnification imaging to be carried out according to an inputted magnification factor only in a case where the inputted magnification factor is within a range of the final acceptable magnification factor.

According to the radiographic phase-contrast imaging method and apparatus of the invention, the radiographic phase-contrast imaging apparatus, where the moving mechanism moves the radiographic image detector in directions of relative movement toward and away from the radiation source to achieve magnification imaging, calculates the acceptable magnification factor, which ensures the radiation transmitted through the first and second gratings to be received within the radiographic image detector, based on size information of the radiographic image detector and size information of at least one of the first and second gratings. Therefore, the radiographic image detector can be moved by a distance according to the magnification factor only when an inputted magnification factor, for example, is within a range of the acceptable magnification factor. Thus, the radiation transmitted through the first and second gratings is reliably received within the detection plane of the radiographic image detector, thereby preventing generation of the missing part of the image, as described above.

In the case where the first and second gratings are adapted to be replaceable, and the size information of the first and second gratings is obtained to calculate the acceptable magnification factor based on the obtained size information of the first and second gratings and the size information of the radiographic image detector, an appropriate acceptable magnification factor can be calculated depending on the size of the first and second gratings.

In the case where the radiation field diaphragm to confine the exposure range of the radiation emitted from the radiation source is disposed between the radiation source and the first grating, and the acceptable radiation field size of the radiation field diaphragm is calculated based on the acceptable magnification factor, the exposure range of the radiation is limited by the radiation field diaphragm according to the acceptable magnification factor, and thus the exposure range of the radiation can more reliably be received within the detection plane of the radiographic image detector.

### BRIEF DESCRIPTION OF THE DRAWINGS

FIG. 1 is a schematic configuration diagram illustrating a breast imaging and display system employing one embodiment of a radiographic phase-contrast imaging apparatus of the present invention,

FIG. 2 is a schematic diagram illustrating a radiation source, first and second gratings, and a radiographic image detector extracted from the breast imaging apparatus shown in FIG. 1,

FIG. 3 is a plan view of the radiation source, the first and second gratings, and the radiographic image detector shown in FIG.

FIG. 4 is a diagram illustrating the schematic structure of the first grating,

FIG. 5 is a diagram illustrating the schematic structure of the second grating,

FIG. 6 is a block diagram illustrating the internal configuration of a computer in the breast imaging and display system shown in FIG. 1,

FIG. 7 is a flow chart for explaining operation of the breast imaging and display system employing one embodiment of the radiographic phase-contrast imaging apparatus of the invention,

FIG. 8 is a diagram for explaining how an acceptable magnification factor is calculated,

FIG. 9 is a diagram illustrating an example of one radiation path which is refracted depending on a phase shift distribution Φ(x) of a subject with respect to an X-direction,

FIG. 10 is a diagram for explaining translational shift of the second grating,

FIG. 11 is a diagram for explaining how a phase contrast image is generated,

FIG. 12 is a block diagram illustrating the internal configuration of the computer of the breast imaging and display system in a case where the first and second gratings are adapted to be replaceable,

FIG. 13 is a diagram illustrating a radiation field diaphragm,

FIG. 14 is a block diagram illustrating the internal configuration of the computer of the breast imaging and display system which calculates an acceptable radiation field size based on the acceptable magnification factor,

FIG. 15 is a diagram for explaining how the acceptable radiation field size is calculated,

FIG. 16 is a diagram for explaining how an acceptable magnification factor candidate is calculated based on a cassette size and a set and inputted radiation field size,

FIG. 17 is a diagram illustrating a positional relationship among the self image of the first grating, the second grating and pixels of the radiographic image detector in a case where a plurality of fringe images are obtained in a single imaging operation,

FIG. 18 is a diagram for explaining how an inclination angle of the self image of the first grating relative to the second grating is set,

FIG. 19 is a diagram for explaining how the inclination angle of the self image of the first grating relative to the second grating is adjusted,

FIG. 20 is a diagram for explaining an operation to obtain the fringe images based on image signals read out from the radiographic image detector,

FIG. 21 is a diagram for explaining the operation to obtain the fringe images based on the image signals read out from the radiographic image detector,

FIG. 22 is a diagram illustrating one example of a radiographic image detector of an optical reading system,

FIG. 23 is a diagram for explaining an operation to record a radiographic image on the radiographic image detector shown in FIG. 22,

FIG. 24 is a diagram for explaining an operation to read out a radiographic image from the radiographic image detector shown in FIG. 22,

FIG. 25 is a diagram for explaining how an absorption image and a small-angle scattering image are generated, and

FIG. 26 is a diagram for explaining a configuration where the first and second gratings are rotated by 90°.

### DESCRIPTION OF THE PREFERRED EMBODIMENTS

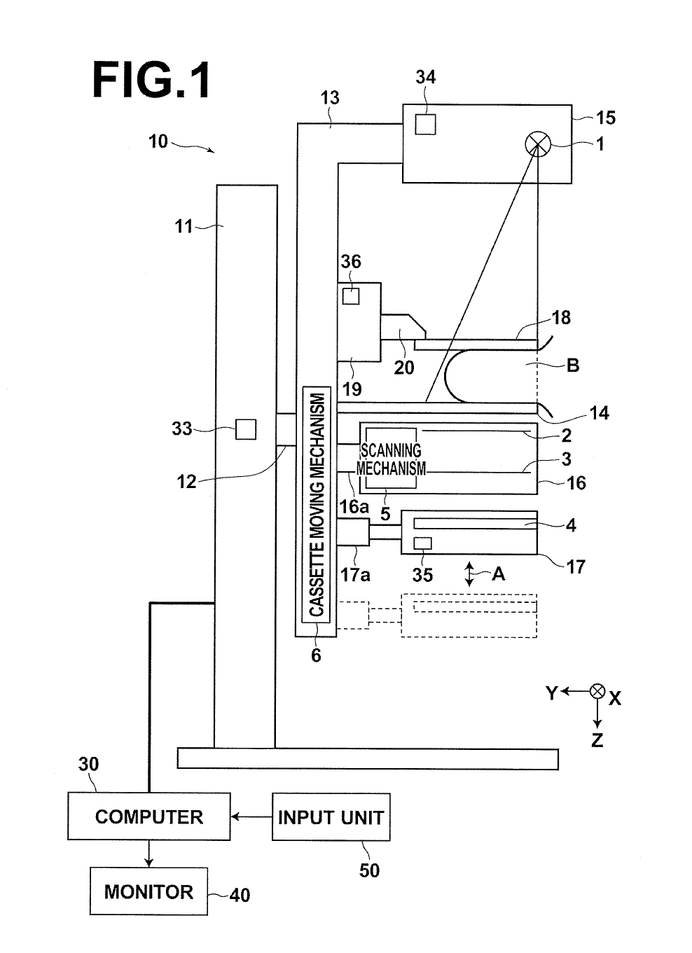

Hereinafter, a breast imaging and display system employing one embodiment of a radiographic phase-contrast imaging apparatus of the present invention will be described with reference to the drawings. FIG. 1 is a schematic configuration diagram of the entire breast imaging and display system employing one embodiment of the invention.

As shown in FIG. 1, this breast imaging and display system includes a breast imaging apparatus 10, a computer 30 connected to the breast imaging apparatus 10, and a monitor 40 and an input unit 50 connected to the computer 30.

Further, as shown in FIG. 1, the breast imaging apparatus 10 includes a base 11, a rotating shaft 12 that is movable in the vertical direction (the Z-direction) and rotatable relative to the base 11, and an arm 13 linked to the base 11 via the rotating shaft 12.

The arm 13 has a “C” shape. An imaging table 14, on which a breast B is placed, is disposed on one side of the arm 13, and a radiation source unit 15 is disposed on the other side of the arm 13 so as to face the imaging table 14. The movement of the arm 13 in the vertical direction is controlled by an arm controller 33, which is built in the base 11.

Further, a grid unit 16 and a cassette unit 17 are disposed in this order from the imaging table 14 on the side of the imaging table 14 opposite from the surface of the imaging table 14 where the breast is placed.

The grid unit 16 is connected to the arm 13 via a grid support 16a. The grid unit 16 contains therein a first grating 2, a second grating 3 and a scanning mechanism 5, which will be described in detail later.

The cassette unit 17 is connected to the arm 13 via a cassette support 17a, on which the cassette unit 17 is supported in a removable manner. The arm 13 contains therein a cassette moving mechanism 6, which moves the cassette support 17a in the vertical direction (the Z-direction). The cassette moving mechanism 6 moves the cassette unit 17 by a distance according to a magnification factor for magnification imaging, and is controlled by the arm controller 33. How the cassette moving mechanism 6 is controlled will be described in detail later.

The cassette unit 17 contains therein a radiographic image detector 4, such as a flat panel detector, and a detector controller 35, which controls reading of electric charge signals from the radiographic image detector 4, etc. Although not shown in the drawing, the cassette unit 17 further contains therein a circuit board, which includes a charge amplifier for converting the electric charge signals read out from the radiographic image detector 4 into voltage signals, a correlated double sampling circuit for sampling the voltage signals outputted from the charge amplifier, an AD conversion unit for converting the voltage signals into digital signals, etc.

The radiographic image detector 4 is of a type that is repeatedly usable to record and read a radiographic image. The radiation detector 4 may be a so-called direct-type radiographic image detector, which directly receives the radiation and generates electric charges, or may be a so-called indirect-type radiographic image detector, which once converts the radiation into visible light, and then, converts the visible light into an electric charge signal. As the reading system to read out the radiographic image signal, a so-called TFT reading system that reads out the radiographic image signal with turning on and off TFT (thin film transistor) switches, or a so-called optical reading system that reads out the radiographic image signal by applying reading light may be used; however, this is not intended to limit the invention, and any other system may be used.

The radiation source unit 15 contains therein a radiation source 1 and a radiation source controller 34. The radiation source controller 34 controls timing of emission of radiation from the radiation source 1 and radiation generation conditions (such as tube current, exposure time, tube voltage, etc.) of the radiation source 1.

Further, a compression paddle 18 disposed above the imaging table 14 for holding and compressing the breast, a compression paddle support 20 for supporting the compression paddle 18, and a compression paddle moving mechanism 19 for moving the compression paddle support 20 in the vertical direction (the Z-direction) are disposed at the arm 13. The position and the compressing pressure of the compression paddle 18 are controlled by a compression paddle controller 36.

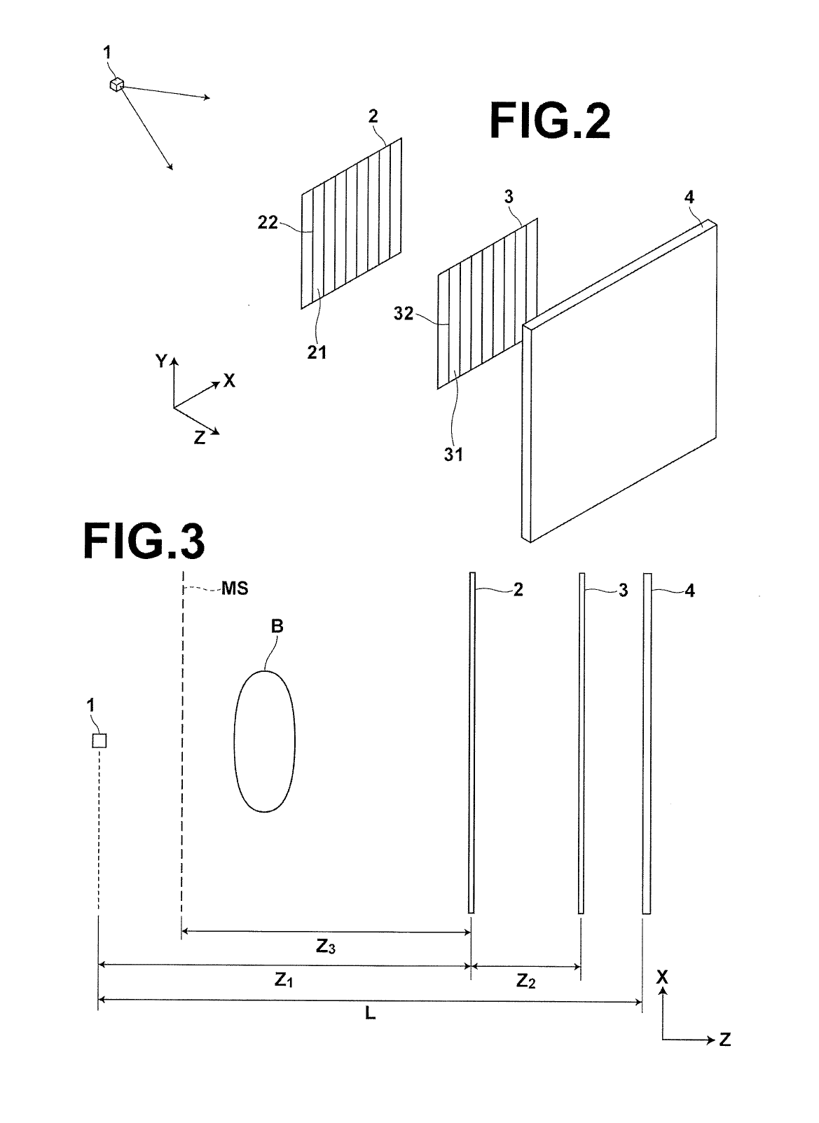

The breast imaging and display system of this embodiment takes a phase contrast image of the breast B with using the radiation source 1, the first grating 2, the second grating 3 and the radiographic image detector 4. Now, the structures of the radiation source 1, the first grating 2 and the second grating 3 required for achieving the phase contrast imaging are described in more detail. FIG. 2 shows the radiation source 1, the first and second gratings 2 and 3 and the radiographic image detector 4 extracted from FIG. 1, and FIG. 3 is a schematic diagram of the radiation source 1, the first and second gratings 2 and 3 and the radiographic image detector 4 shown in FIG. 2 viewed from above.

The radiation source 1 emits radiation toward the breast B. The spatial coherence of the radiation is such that the Talbot interference effect occurs when the radiation is applied to the first grating 2. For example, a microfocus X-ray tube or a plasma X-ray source, which provides a small radiation emission point, may be used. In a case where a radiation source with a relatively large radiation emission point (a so-called focal spot size) is used, as in a clinical practice, a multislit MS with a predetermined pitch may be disposed on the radiation emission side. The detailed configuration of this case is described, for example, in Franz Pfeiffer, Timm Weikamp, Oliver Bunk, and Christian David, “Phase retrieval and differential phase-contrast imaging with low-brilliance X-ray sources”, Nature Physics 2, 258-261 (1 Apr. 2006) Letters. It is necessary to determine a pitch P₀ of the slit MS to satisfy Expression (1) below:

P₀=P₂×Z₃/Z₂ (1)

where P₂ is a pitch of the second grating 3, Z₃ is a distance from the position of the multislit MS to the first grating 2, as shown in FIG. 3, and Z₂ is a distance from the first grating 2 to the second grating 3.

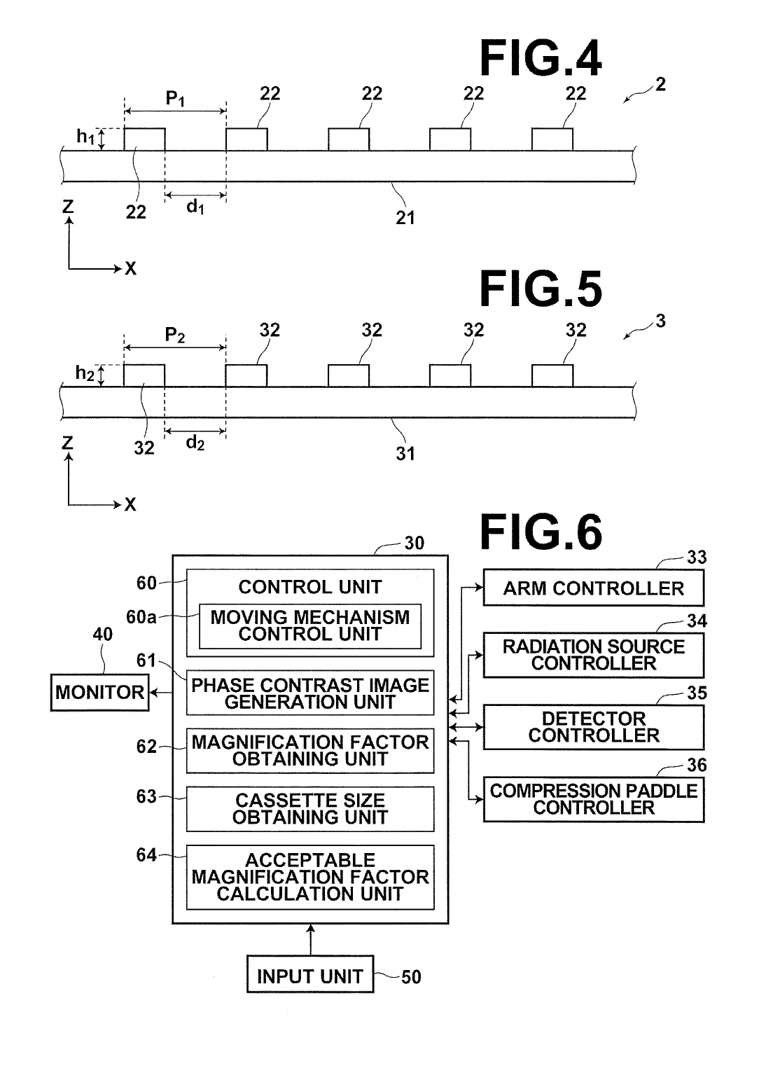

The first grating 2 allows the radiation emitted from the radiation source 1 to pass therethrough to form a first periodic pattern image, and includes a substrate 21, which mainly transmits the radiation, and a plurality of members 22 disposed on the substrate 21, as shown in FIG. 4. The members 22 are linear members extending along one direction in a plane orthogonal to the optical axis of the radiation (the Y-direction orthogonal to the X-direction and Z-direction, i.e., the direction orthogonal to the plane of FIG. 4). The members 22 are arranged at a predetermined interval d₁ with a constant period P₁ along the X-direction. The material forming the members 22 may be a metal, such as gold or platinum. It is desirable that the first grating 2 is a so-called phase modulation grating, which applies phase modulation of about 90° or about 180° to the radiation applied thereto. If the members 22 are made of gold, for example, the necessary thickness h₁ of the members 22 for an X-ray energy region for usual medical diagnosis is on the order of one micrometer to ten micrometers. Alternatively, an amplitude modulation grating may be used. In this case, the members 22 need to have a thickness for sufficiently absorbing the radiation. If the members 22 are made of gold, for example, the necessary thickness h₁ of the members 22 for an X-ray energy region for usual medical diagnosis is on the order of ten micrometers to several hundreds micrometers.

The second grating 3 applies intensity modulation to the first periodic pattern image formed by the first grating 2 to form a second periodic pattern image, and includes, similarly to the first grating 2, a substrate 31, which mainly transmits the radiation, and a plurality of members 32 disposed on the substrate 31, as shown in FIG. 5. The members 32 shield the radiation. The members 32 are linear members extending along one direction in a plane orthogonal to the optical axis of the radiation (the Y-direction orthogonal to the X-direction and Z-direction, i.e., the direction orthogonal to the plane of FIG. 5). The members 32 are arranged at a predetermined interval d₂ with a constant period P₂ along the X-direction. The material forming the members 32 may be a metal, such as gold or platinum. It is desirable that the second grating 3 is an amplitude modulation grating. In this case, the members 32 need to have a thickness for sufficiently absorbing the radiation. If the members 32 are made of gold, for example, the necessary thickness h₂ of the members 32 for an X-ray energy region for usual medical diagnosis is on the order of ten micrometers to several hundreds micrometers.

In a case where the radiation emitted from the radiation source 1 is not a parallel beam but a cone beam, the self image G1 of the first grating 2 formed by the radiation passed through the first grating 2 is magnified in proportion to the distance from the radiation source 1. In this embodiment, the grating pitch P₂ and the interval d₂ of the second grating 3 are determined such that the slits of the second grating 3 are almost aligned with the periodic pattern of light areas of self image G1 of the first grating 2 at the position of the second grating 3. That is, assuming that the distance from the focal spot of the radiation source 1 to the first grating 2 is Z₁ and the distance from the first grating 2 to the second grating 3 is Z₂, in the case where the first grating 2 is a phase modulation grating that applies phase modulation of 90° or an amplitude modulation grating, the pitch P₂ of the second grating is determined to satisfy the relationship defined as the Expressions (2) below:

$${P}_{2} = {P}_{1}^{′} = \frac{{Z}_{1} + {Z}_{2}}{{Z}_{1}} {P}_{1} \qquad ( 2 )$$

where P₁′ is a pitch of the self image G1 of the first grating 2 at the position of the second grating 3. Alternatively, in the case where the first grating 2 is a phase modulation grating that applies phase modulation of 180°, the pitch P₂ of the second grating is determined to satisfy the relationship defined as the Expressions (3) below:

$${P}_{2} = {P}_{1}^{′} = \frac{{Z}_{1} + {Z}_{2}}{{Z}_{1}} \cdot \frac{{P}_{1}}{2} \qquad ( 3 )$$

In order to make the breast imaging apparatus 10 of this embodiment function as a Talbot interferometer, some more conditions must almost be satisfied. Now, the conditions are described.

First, it is necessary that grid planes of the first grating 2 and the second grating 3 are parallel to the X-Y plane shown in FIG. 2.

Further, if the first grating 2 is a phase modulation grating that applies phase modulation of 90°, then, the distance Z₂ between the first grating 2 and the second grating 3 must almost satisfy the condition below:

$${Z}_{2} = ( m + \frac{1}{2} ) \frac{{P}_{1} {P}_{2}}{λ} \qquad ( 4 )$$

where λ is the wavelength of the radiation (which is typically the effective wavelength), m is 0 or a positive integer, P₁ is the above-described grating pitch of the first grating 2, and P₂ is the above-described grating pitch of the second grating 3.

Alternatively, if the first grating 2 is a phase modulation grating that applies phase modulation of 180°, then, the distance Z₂ between the first grating 2 and the second grating 3 must almost satisfy the condition below:

$${Z}_{2} = ( m + \frac{1}{2} ) \frac{{P}_{1} {P}_{2}}{2 λ} \qquad ( 5 )$$

where λ is the wavelength of the radiation (which is typically the effective wavelength), m is 0 or a positive integer, P₁, is the above-described grating pitch of the first grating 2, and P₂ is the above-described grating pitch of the second grating 3.

Still alternatively, if the first grating 2 is an amplitude modulation grating, then, the distance Z₂ between the first grating 2 and the second grating 3 must almost satisfy the condition below:

$${Z}_{2} = {m}^{′} \frac{{P}_{1} {P}_{2}}{λ} \qquad ( 6 )$$

where λ is the wavelength of the radiation (which is typically the effective wavelength), m′ is a positive integer, P₁ is the above-described grating pitch of the first grating 2, and P₂ is the above-described grating pitch of the second grating 3.

Further, as shown in FIGS. 4 and 5, the members 22 of the first grating 2 are formed to have the thickness h₁ and the members 32 of the second grating 3 are formed to have the thickness h₂. If the thickness h₁, and the thickness h₂ are excessively thick, it is difficult for parts of the radiation that obliquely enter the first grating 2 and the second grating 3 to pass through the slits of the gratings, and this results in so-called vignetting, which narrows an effective field of view in a direction (the X-direction) orthogonal to the direction along which the members 22 and 32 extend. In view of ensuring the field of view, it is preferred to define the upper limits of the thicknesses h₁ and h₂. In order to ensure a length V of the effective field of view in the X-direction in the detection plane of the radiographic image detector 4, it is preferred to set the thicknesses h₁ and h₂ to satisfy Expressions (7) and (8) below:

$$\begin{matrix}{h}_{1} \leq \frac{L}{V / 2} {d}_{1} & ( 7 ) \\ {h}_{2} \leq \frac{L}{V / 2} {d}_{2} & ( 8 )\end{matrix}$$

where L is a distance from the focal spot of the radiation source 1 to the detection plane of the radiographic image detector 4 (see FIG. 3).

The scanning mechanism 5 disposed in the grid unit 16 shifts the position of the second grating 3 as described above to translate it in the direction (the X-direction) orthogonal to the direction along which the members 32 extend, thereby changing the relative positions of the first grating 2 and the second grating 3. The scanning mechanism 5 may be formed, for example, by an actuator, such as a piezoelectric device. Then, the second periodic pattern image formed by the second grating 3 at each position of the second grating 3 shifted by the scanning mechanism 5 is detected by the radiographic image detector 4.

FIG. 6 is a block diagram illustrating the configuration of the computer 30 shown in FIG. 1. The computer 30 includes a central processing unit (CPU), a storage device, such as a semiconductor memory, a hard disk or a SSD, etc., and these hardware devices form a control unit 60, a phase contrast image generation unit 61, a magnification factor obtaining unit 62, a cassette size obtaining unit 63 and an acceptable magnification factor calculation unit 64, as shown in FIG. 6.

The control unit 60 outputs predetermined control signals to the various controllers 33 to 36 to control the entire system. The control unit 60 includes a moving mechanism control unit 60a. The moving mechanism control unit 60a controls the cassette moving mechanism 6, shown in FIG. 1, based on a magnification factor for magnification imaging inputted via the input unit 50. Specific control exerted by the control unit 60 and the moving mechanism control unit 60a will be described in detail later.

The phase contrast image generation unit 61 generates a radiation phase contrast image based on image signals of a plurality of different fringe images, which are detected by the radiographic image detector 4 at different positions of the second grating 3. The method for generating the radiation phase contrast image will be described in detail later.

The magnification factor obtaining unit 62 obtains the magnification factor for magnification imaging inputted via the input unit 50, and outputs the magnification factor to the control unit 60.

The cassette size obtaining unit 63 obtains information of cassette size inputted via the input unit 50, and outputs the information of cassette size to the acceptable magnification factor calculation unit 64. In this embodiment, the cassette size is substantially the size of the radiographic image detector 4 in the cassette unit 17, and the length of the shorter side of two sides orthogonal to each other of the radiographic image detector 4 is used as the cassette size. Although the information of cassette size is inputted via the input unit 50 in this embodiment, this is not intended to limit the invention. For example, the size information may be stored in the cassette unit 17, and the cassette size may be obtained by the cassette size obtaining unit 63 by reading the size information.

The acceptable magnification factor calculation unit 64 calculates an acceptable magnification factor based on the cassette size outputted from the cassette size obtaining unit 63 and the size of the first and second gratings 2 and 3 set in advance, and outputs the calculated acceptable magnification factor to the control unit 60. In this embodiment, the acceptable magnification factor is a maximum magnification factor with which the radiation transmitted through the first and second gratings is received within the detection plane of the radiographic image detector 4 during magnification imaging. The size of the first and second gratings 2 and 3 in this embodiment is the length of one side of two sides orthogonal to each other of the first and second gratings 2 and 3 in the same direction as the direction of the one side which is selected as the cassette size, i.e., the shorter side of the two sides orthogonal to each other of the radiographic image detector 4. How the acceptable magnification factor is calculated will be described in detail later.

The monitor 40 displays the phase contrast image generated by the phase contrast image generation unit 61 in the computer 30.

The input unit 50 includes, for example, a keyboard and a pointing device, such as a mouse. The input unit 50 receives an input, such as imaging conditions and an instruction to start imaging, by the operator. In this embodiment, the input unit 50 receives, in particular, an input of the cassette size of the cassette unit 17 mounted on the arm 13 and the magnification factor for magnification imaging.

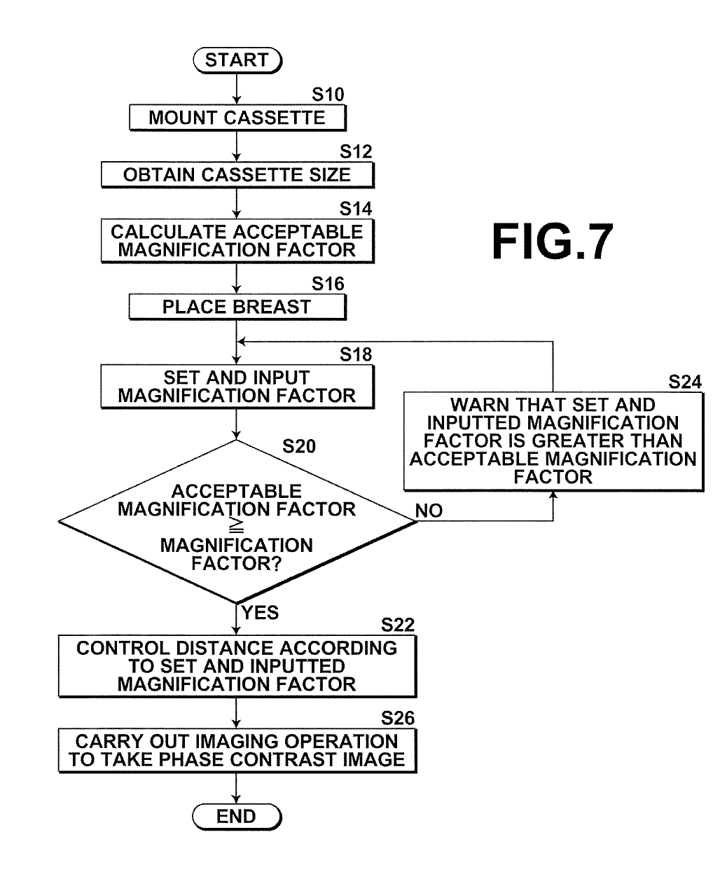

Next, operation of the breast imaging and display system of this embodiment is described with reference to the flow chart shown in FIG. 7.

First, depending on the size of the breast of the patient, the purpose of imaging, etc., the cassette unit 17 of an appropriate size is mounted on the cassette support 17a at the arm 13 (S10).

Examples of the cassette size may include, but not limited to, 18 cm×24 cm, 24 cm×30 cm, 17 inches×17 inches, 17 inches×14 inches, 9 inches×9 inches, etc.

Then, the cassette size of the mounted cassette unit 17 is inputted by the operator via the input unit 50 and is obtained by the cassette size obtaining unit 63 (S12). The cassette size obtained by the cassette size obtaining unit 63 is outputted to the acceptable magnification factor calculation unit 64, and the acceptable magnification factor calculation unit 64 calculates the acceptable magnification factor based on the inputted cassette size and the size of the first and second gratings 2 and 3 set in advance.

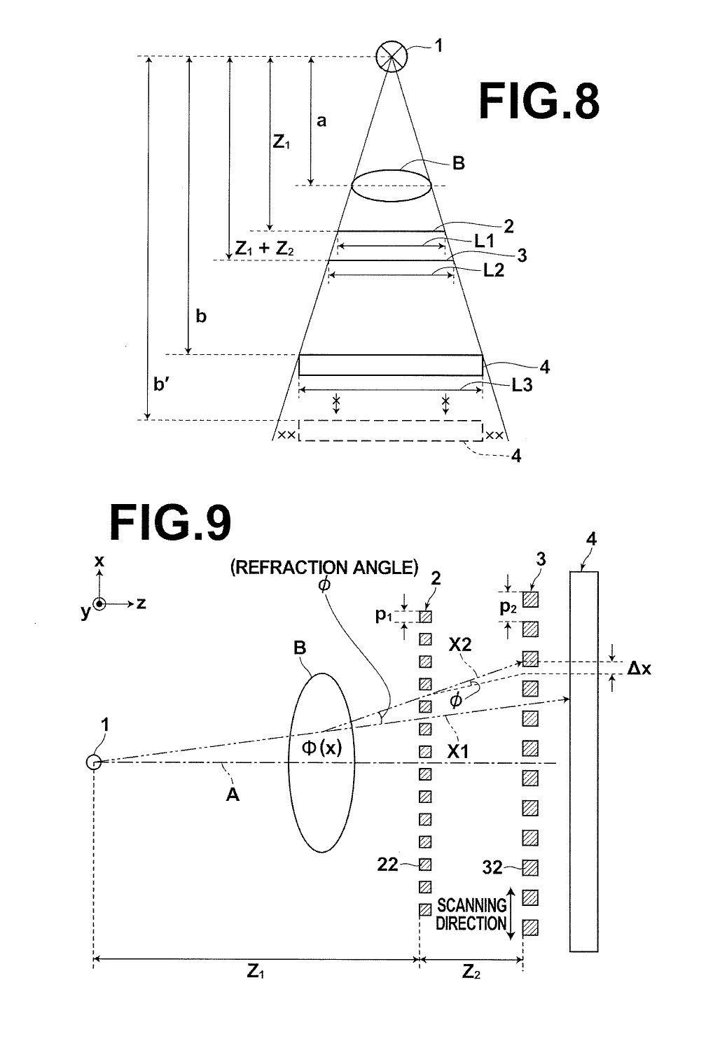

Specifically, first, as shown in FIG. 8, assuming that a distance between the radiation source 1 and the breast B is “a” and a distance between the radiation source 1 and the detection plane of the radiographic image detector 4 is “b”, the magnification factor M can be expressed as M=b/a. Then, assuming that the size of the first grating 2 is L1, the size of the second grating 3 is L2, and the cassette size is L3, smaller one of the magnification factors M satisfying Expressions (9) and (10) below is calculated as the acceptable magnification factor:

$$\begin{matrix}M = \frac{L 3}{L 1} \times \frac{{Z}_{1}}{a} & ( 9 ) \\ M = \frac{L 3}{L 2} \times \frac{{Z}_{1} + {Z}_{2}}{a} & ( 10 )\end{matrix}$$

It should be noted that the values of Z₁ and Z₂ are typically set in advance to satisfy Expression (2) or (3) above.

Further, in this embodiment, although the acceptable magnification factor is calculated with taking both the size of the first grating 2 and the size of the second grating 3 into account, this is not intended to limit the invention. The acceptable magnification factor may be calculated based on the size of one of the first grating 2 and the second grating 3.

For example, if a cone beam is used as the radiation, one of the gratings nearer to the radiation source 1 provides a greater magnification factor on the radiographic image detector 4. Therefore, it may be desirable that the acceptable magnification factor is calculated based on the size of the first grating 2.

Further, since the effective field of view needs to transmit through both the first grating 2 and the second grating 3, the range of each of the first grating 2 and the second grating 3 through which the radiation transmits may be converted into an area on the radiographic image detector 4, and the size of one of the gratings with a smaller area may be used to calculate the acceptable magnification factor.

That is, a maximum magnification factor, with which the radiation transmitted through the first and second gratings 2 and 3 is received within the detection plane of the radiographic image detector 4 during magnification imaging, is calculated as the acceptable magnification factor. Then, the acceptable magnification factor calculation unit 64 outputs the thus calculated acceptable magnification factor to the control unit 60. It should be noted that, if a magnification factor greater than the acceptable magnification factor is used for imaging, i.e., if imaging is carried out with moving the radiographic image detector 4 to the position b′ shown in FIG. 8, part of the radiation transmitted through the first and second gratings 2 and 3 is not received within the detection plane of the radiographic image detector 4, and thus part of the radiographic image of the breast is not received within the detection plane of the radiographic image detector 4 and the resulting radiographic image does not contain the entire range of the subject intended to be imaged. In this case, it is impossible to diagnose the missing part, and the subject is exposed to extra radiation at the missing part of the image. In the breast imaging and display system of this embodiment, the magnification factor for magnification imaging is limited as follows to prevent such problems.

First, the acceptable magnification factor calculated as described above is outputted to the control unit 60 to be set. Then, the breast B of the patient is placed on the imaging table 14, and the compression paddle 18 compresses the breast B with a predetermined pressure (S16).

Subsequently, a magnification factor for magnification imaging is inputted by the operator via the input unit 50 (S18). The magnification factor received via the input unit 50 is obtained by the magnification factor obtaining unit 62 and is outputted to the control unit 60.

Then, the control unit 60 compares the inputted magnification factor with the acceptable magnification factor calculated as described above. If the magnification factor set and inputted by the operator is not greater than the acceptable magnification factor, the moving mechanism control unit 60a of the control unit 60 outputs a control signal to the arm controller 33 so that the magnification imaging is carried out according to the magnification factor, and the arm controller 33 controls driving by the cassette moving mechanism 6 according to the control signal so that the cassette moving mechanism 6 moves the cassette unit 17 in the vertical direction (S20: YES). That is, the cassette moving mechanism 6 moves the cassette unit 17 along the Z-direction such that the distance b between the radiation source 1 and the detection plane of the radiographic image detector 4 becomes a distance according to the magnification factor set and inputted by the operator (522).

In contrast, if the magnification factor set and inputted by the operator is greater than the acceptable magnification factor, the control unit 60 outputs, via the monitor 40, a warning message for warning the operator with the fact that the set and inputted magnification factor is greater than the acceptable magnification factor, together with the acceptable magnification factor, and also outputs a message to prompt the operator to input another magnification factor which is not greater than the acceptable magnification factor (S20: NO, S24). Then, another magnification factor which is not greater than the acceptable magnification factor is inputted by the operator.

In this manner, the magnification factor which is not greater than the acceptable magnification factor is set, and the cassette unit 17 is moved at a position according to the magnification factor. Then an imaging operation to take the phase contrast image is carried out (S26).

Next, the imaging operation to take the phase contrast image of this embodiment is described in detail.

First, the breast B is placed as described above, and the position of the cassette unit 17 is controlled. Then, radiation is emitted from the radiation source 1 in response to an input of an instruction to start imaging by the operator. The radiation is transmitted through the breast B and is applied onto the first grating 2. The radiation applied onto the first grating 2 is diffracted by the first grating 2 to form a Talbot interference image at a predetermined distance from the first grating 2 in the direction of the optical axis of the radiation.

This phenomenon is called the Talbot effect where, when the light wave passes through the first grating 2, a self image G1 of the first grating 2 is formed at a predetermined distance from the first grating 2. For example, in the case where the first grating 2 is a phase modulation grating that applies phase modulation of 90°, the self image G1 of the first grating 2 is formed at the distance found by Expression (4) above (Expression (5) above in the case where the first grating 2 is a phase modulation grating that applies phase modulation of 180°, and Expression (6) above in the case where the first grating 2 is an intensity modulation grating). On the other hand, the wave front of the radiation entering the first grating 2 is distorted by the breast B, which is the subject, and the self image G1 of the first grating 2 is deformed accordingly.

Subsequently, the radiation passes through the second grating 3. As a result, the deformed self image G1 of the first grating 2 is superposed on the second grating 3 to be subjected to intensity modulation, and then is detected by the radiographic image detector 4 as an image signal which reflects the above-described distortion of the wave front. Then, the image signal detected by the radiographic image detector 4 is inputted to the phase contrast image generation unit 61 of the computer 30.

Next, how the phase contrast image is generated at the phase contrast image generation unit 61 is described. First, the principle of a method for generating the phase contrast image in this embodiment is described.

FIG. 9 shows an example of one radiation path which is refracted depending on a phase shift distribution Φ(x) of the subject B with respect to the X-direction. The symbol X1 denotes a straight radiation path in a case where the subject B is not present. The radiation traveling along the path X1 passes through the first grating 2 and the second grating 3 and enters the radiographic image detector 4. The symbol X2 denotes a radiation path which is deflected due to refraction by the subject B in a case where the subject B is present. The radiation traveling along the path X2 passes through the first grating 2, and then is shielded by the second grating 3.

Assuming that a refractive index distribution of the subject B is n (x,z), and a direction in which the radiation travels is z, the phase shift distribution Φ(x) of the subject B is expressed by Expression (11) below (where the y-coordinate is omitted for simplifying explanation):

$$Φ ( x ) = \frac{2 π}{λ} {\int }_{ }^{ } [ 1 - n ( x , z ) ] d z \qquad ( 11 )$$

A self image G1 formed by the first grating 2 at the position of the second grating 3 is displaced in the x-direction by an amount depending on the refraction angle φ of the refraction of radiation by the subject B. The amount of displacement Δx is approximately expressed by Expression (12) below based on the fact that the refraction angle φ of the radiation is very small:

Δx≈Z₂φ (12)

The refraction angle φ is expressed by Expression (13) below with using the wavelength λ of the radiation and the phase shift distribution Φ(x) of the subject B:

$$ϕ = \frac{λ}{2 π} \frac{\partial Φ ( x )}{\partial x} \qquad ( 13 )$$

In this manner, the amount of displacement Δx of the self image G1 due to the refraction of radiation by the subject B is linked to the phase shift distribution Φ(x) of the subject B. Then, the amount of displacement Δx is linked to an amount of phase shifting Ψ of an intensity-modulated signal of each pixel detected by the radiographic image detector 4 (an amount of phase shifting of the intensity-modulated signal of each pixel between the cases where the subject B is present and where the subject B is not present), as expressed by Expression (14) below:

$$ψ = \frac{2 π}{{P}_{2}} \\ Δ x = \frac{2 π}{{P}_{2}} {Z}_{2} ϕ \qquad ( 14 )$$

Therefore, by finding the amount of phase shifting Ψ of the intensity-modulated signal of each pixel, the refraction angle φ is found from Expression above (14), and a differential of the phase shift distribution Φ(x) is found with using Expression (13) above. By integrating the differential with respect to x, the phase shift distribution Φ(x) of the subject 10, i.e., the phase contrast image of the subject B can be generated. In this embodiment, the amount of phase shifting Ψ is calculated with using the fringe scanning method described below.

In the fringe scanning method, the imaging operation as described above is carried out with shifting (translating) one of the first grating 2 and the second grating 3 in the X-direction relative to the other of the first grating 2 and the second grating 3. In this embodiment, the second grating 3 is shifted by the scanning mechanism 5. As the second grating 3 is shifted, the fringe image detected by the radiographic image detector 4 moves. When a translation distance (an amount of shift in the X-direction) reaches one period of the arrangement period of the second grating 3 (the arrangement pitch P₂), i.e., when the phase variation reaches 2π, the fringe image returns to the initial position. Such variation of the fringe image is detected by the radiographic image detector 4 with shifting the second grating 3 by a fraction of the arrangement pitch P₂ divided by an integer to detect a plurality of fringe images, and the intensity-modulated signal of each pixel is obtained from the detected fringe images to obtain the amount of phase shifting Ψ of the intensity-modulated signal of each pixel.

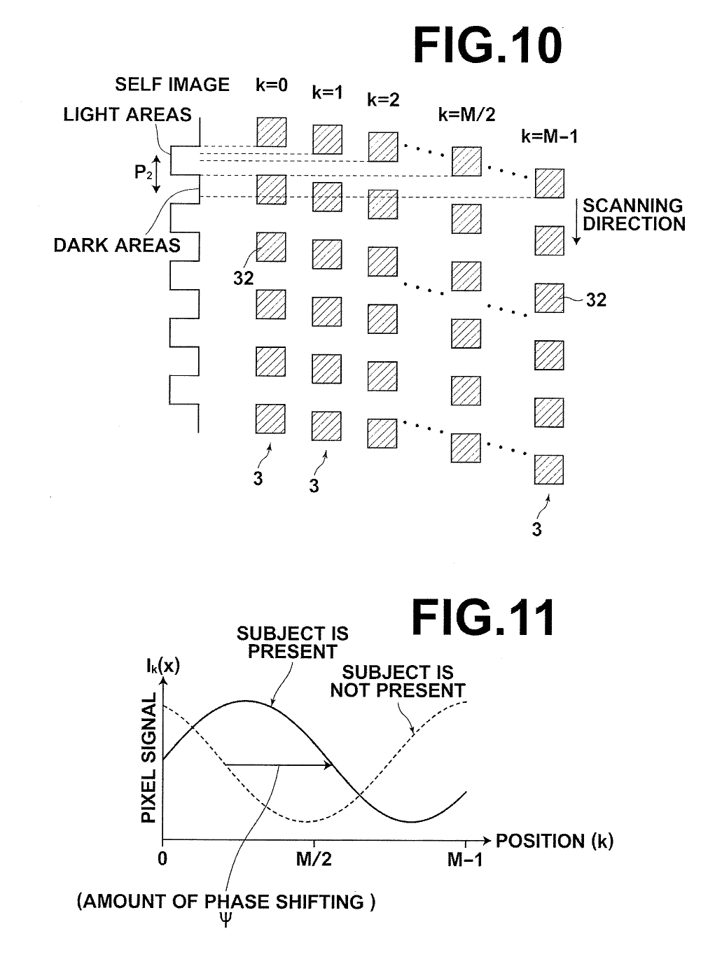

FIG. 10 schematically shows how the second grating 3 is shifted by a pitch (P₂/M), which is a fraction of the arrangement pitch P₂ divided by M (which is an integer of 2 or more). The scanning mechanism 5 shifts the second grating 3 sequentially to M positions k (k=0, 1, 2, . . . , and M−1). It should be noted that, in FIG. 10, the initial position of the second grating 3 is a position of k=0 where, in the case where the subject B is not present, dark areas of the self image G1 of the first grating 2 at the position of the second grating 3 are almost aligned with the members 32 of the second grating 3. However, the initial position of the second grating 3 may be any of the M positions k (k=0, 1, 2, . . . , and M−1).

First, at the position of k=0, mainly part of the radiation that has not been refracted by the subject B passes through the second grating 3. As the second grating 3 is shifted sequentially to the positions of k=1, 2, . . . , and the like, a component of the radiation passing through the second grating 3 that has not been refracted by the subject B decreases, and a component of the radiation passing through the second grating 3 that has been refracted by the subject B increases. In particular, at the position of k=M/2, mainly, only the component of the radiation refracted by the subject B passes through the second grating 3. In contrast, at the positions beyond the position of k=M/2, the component of the radiation passing through the second grating 3 that has been refracted by the subject B decreases, and the component of the radiation passing through the second grating 3 that has not been refracted by the subject B increases.

By carrying out imaging by the radiographic image detector 4 at each of the positions of k=0, 1, 2, . . . , and M−1, M fringe image signals are obtained, and the image signals are stored in the phase contrast image generation unit 61.

Now, how the amount of phase shifting Ψ of the intensity-modulated signal of each pixel is calculated from pixel signals for each pixel of the M fringe image signals is described.

First, each pixel signal Ik(x) for each pixel at each position k of the second grating 3 is expressed by Expression (15) below:

$${I}_{k} ( x ) = {A}_{0} + {\sum }_{n > 0} {A}_{n} exp [ 2 π i \frac{n}{{P}_{2}} \{ {Z}_{2} ϕ ( x ) + \frac{{kP}_{2}}{M} \} ] \qquad ( 15 )$$

where x is a coordinate of the pixel with respect to the x-direction, A₀ is an intensity of the incident radiation, and A₁, is a value corresponding to the contrast of the intensity-modulated signal (where n is a positive integer). Further, ψ(x) represents the refraction angle φ as a function of the coordinate x of each pixel of the radiographic image detector 4.

Then, using the relational expression of Expression (16) below, the refraction angle φ(x) is expressed as Expression (17) below:

$$\begin{matrix}{\sum }_{k = 0}^{M - 1} exp ( - 2 π i \frac{k}{M} ) = 0 & ( 16 ) \\ ϕ ( x ) = \frac{{p}_{2}}{2 π {Z}_{2}} arg [ {\sum }_{k = 0}^{M - 1} {I}_{k} ( x ) exp ( - 2 π i \frac{k}{M} ) ] & ( 17 )\end{matrix}$$

where “arg[ ]” means extraction of an argument, and corresponds to the amount of phase shifting Ψ of the intensity-modulated signal at each pixel of the radiographic image detector 4. Therefore, the refraction angle φ(x) is found by calculating, based on Expression (17), the amount of phase shifting Ψ of the intensity-modulated signal of each pixel of the phase contrast image from the pixel signals of the M fringe image signals obtained for each pixel of the radiographic image detector 4.

Specifically, as shown in FIG. 11, the M fringe image signals obtained for each pixel of the radiographic image detector 4 periodically vary with the period of the grating pitch P₂ of the second grating 3 relative to the position k of the second grating 3. In FIG. 11, the dashed line represents the variation of the fringe image signal in the case where the subject B is not present, and the solid line represents the variation of the fringe image signal in the case where the subject B is present. The phase difference between these waveforms corresponds to the amount of phase shifting W of the intensity-modulated signal of each pixel.

Since the refraction angle φ(x) is a value corresponding to the differential value of the phase shift distribution Φ(x), as expressed by Expression (13) above, the phase shift distribution Φ(x) can be obtained by integrating the refraction angle φ(x) along the x-axis.

Although the y-coordinate of each pixel with respect to the y-direction is not taken into account in the above description, similar calculation may be carried out for each y-coordinate to obtain a two-dimensional distribution of refraction angle φ(x,y). In this case, a two-dimensional phase shift distribution Φ(x,y) can be obtained as the phase contrast image by integrating the two-dimensional distribution of refraction angle φ(x) along the x-axis.

Alternatively, the phase contrast image may be generated by integrating a two-dimensional distribution of amount of phase shifting Ψ(x,y) along the x-axis, in place of the two-dimensional distribution of refraction angle φ(x,y).

The two-dimensional distribution of refraction angle φ(x,y) and the two-dimensional distribution of amount of phase shifting Ψ(x,y) correspond to the differential value of the phase shift distribution Φ(x,y), and thus are called differential phase images. The differential phase image may be generated as the phase contrast image.

In this manner, the phase contrast image is generated by the phase contrast image generation unit 61 based on the plurality of fringe images.

Further, while the cassette unit 17 is adapted to be replaceable in the above-described embodiment, the grid unit 16 may also be adapted to be replaceable depending on the type and size of the subject, the imaging method, etc. Examples of the size of the first grating 2 and the second grating 3 may include, but not limited to, 6 inches×6 inches, 8 inches×8 inches, 10 inches 10 inches, etc.

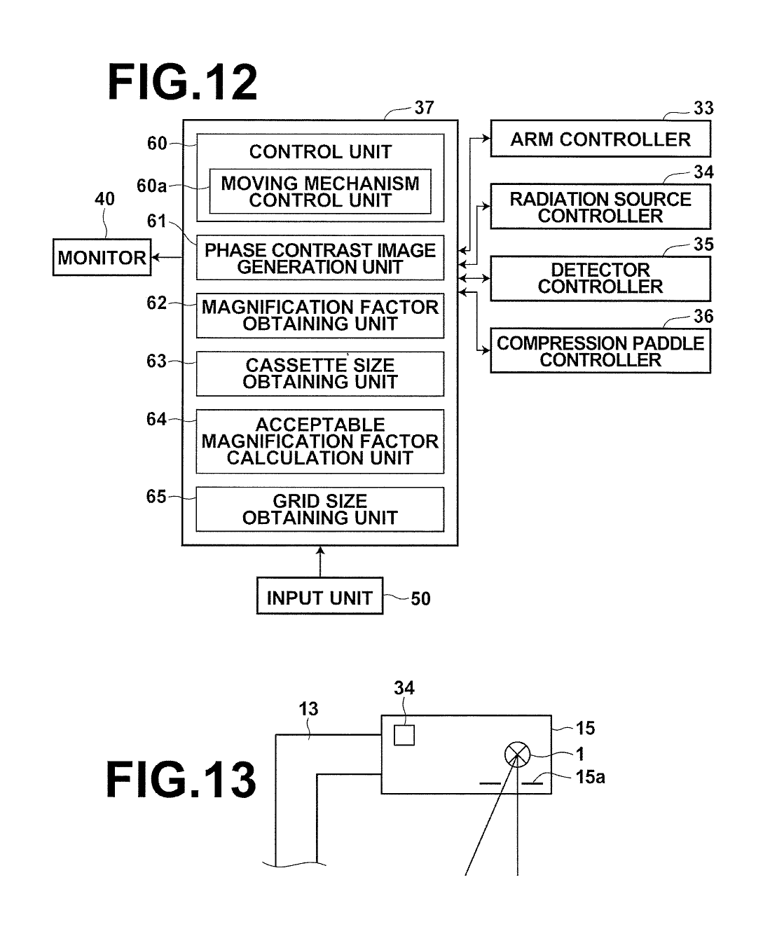

In the case where the grid unit 16 is adapted to be replaceable, the acceptable magnification factor calculation unit 64 may calculate the acceptable magnification factor based on size information of the grid unit 16 mounted on the apparatus. Specifically, as shown in FIG. 12, a grid size obtaining unit 65 for obtaining the size information of the first and second gratings 2 and 3 may further be provided in a computer 37, and the acceptable magnification factor calculation unit 64 may calculate the acceptable magnification factor with using the size information of the first and second gratings 2 and 3 obtained by the grid size obtaining unit 65. It should be noted that the grid size obtaining unit 65 may obtain the size information of the first and second gratings 2 and 3 which is inputted by the operator via the input unit 50 and received, or the size information of the first and second gratings 2 and 3 contained in each grid unit 16 may be stored in the grid unit 16 and the grid size obtaining unit 65 may read and obtain the stored size information.

As a modification of the above-described embodiment, a radiation field diaphragm 15a to confine an exposure range of the radiation emitted from the radiation source 1 may be provided in the radiation source unit 15, as shown in FIG. 13. In the case where the radiation field diaphragm 15a is provided, an acceptable radiation field size of the radiation field diaphragm 15a may be calculated based on the magnification factor, which is set to be not greater than the acceptable magnification factor Mac as described above, so that the exposure range of the radiation confined by the radiation field diaphragm 15a is reliably received within the detection plane of the radiographic image detector 4.

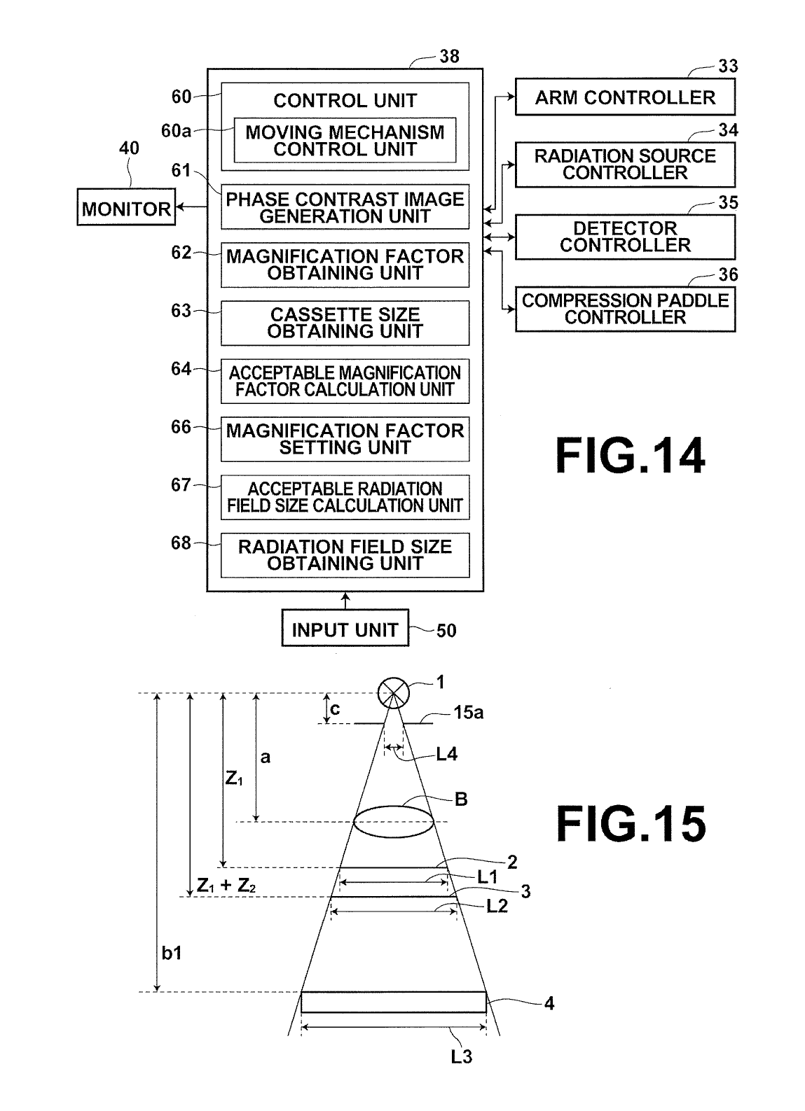

Specifically, as shown in FIG. 14, a magnification factor setting unit 66, an acceptable radiation field size calculation unit 67 and a radiation field size obtaining unit 68 are further provided in a computer 38. The magnification factor setting unit 66 sets the magnification factor M in a range not greater than the acceptable magnification factor Mac. It should be noted that the magnification factor M may be set and inputted by the operator and obtained by magnification factor obtaining unit 62, or a magnification factor M not greater than the acceptable magnification factor Mac may automatically be set by the magnification factor setting unit 66.

Since the magnification factor M=b/a, the moving mechanism control unit 60a sets the distance b between the focal spot of the radiation source 1 and the detection plane of the radiographic image detector 4 at b1, as shown in FIG. 15, for example, based on the set magnification factor M and the distance a between the focal spot of the radiation source 1 and the subject.

Then, the acceptable radiation field size calculation unit 66 calculates an acceptable radiation field size Lac from the size L3 of the radiographic image detector 4, a distance c between the focal spot of the radiation source 1 and the radiation field diaphragm, based on Expression below:

Lac=L3×c/b1.

Then, the radiation field size obtaining unit 67 obtains size information of the radiation field diaphragm set and inputted by the operator, and the control unit 60 compares the set and inputted radiation field size L4 with the acceptable radiation field size Lac, which is calculated as described above. If the set and inputted radiation field size is not greater than the acceptable radiation field size, the control unit 60 outputs a control signal to the radiation field diaphragm 15a to control the diaphragm so that the set and inputted radiation field size is achieved.

In contrast, if the radiation field size set and inputted by the operator is greater than the acceptable radiation field size, the control unit 60 limits the aperture of the radiation field diaphragm 15a so that the radiation field size is equal to or not greater than the acceptable radiation field size. In this case, a warning message for warning the operator with the fact that the set and inputted radiation field size is greater than the acceptable radiation field size may be outputted, together with the acceptable radiation field size, via the monitor 40, and a message to prompt the operator to input another radiation field size which is not greater than acceptable radiation field size may be outputted via the monitor 40. Then, the control unit 60 may control the aperture of the radiation field diaphragm 15a based on another radiation field size which is not greater than the acceptable radiation field size inputted by the operator.

As a modification of the above-described embodiment, the control unit 60 may obtain the acceptable magnification factor Mac, which is calculated based on the cassette size and the first and second gratings 2 and 3, as a first acceptable magnification factor candidate, and may further calculate a second acceptable magnification factor candidate based on the cassette size and the radiation field size obtained by the radiation field size obtaining unit 67.

Namely, there is a relationship:

c/L4=b/L3

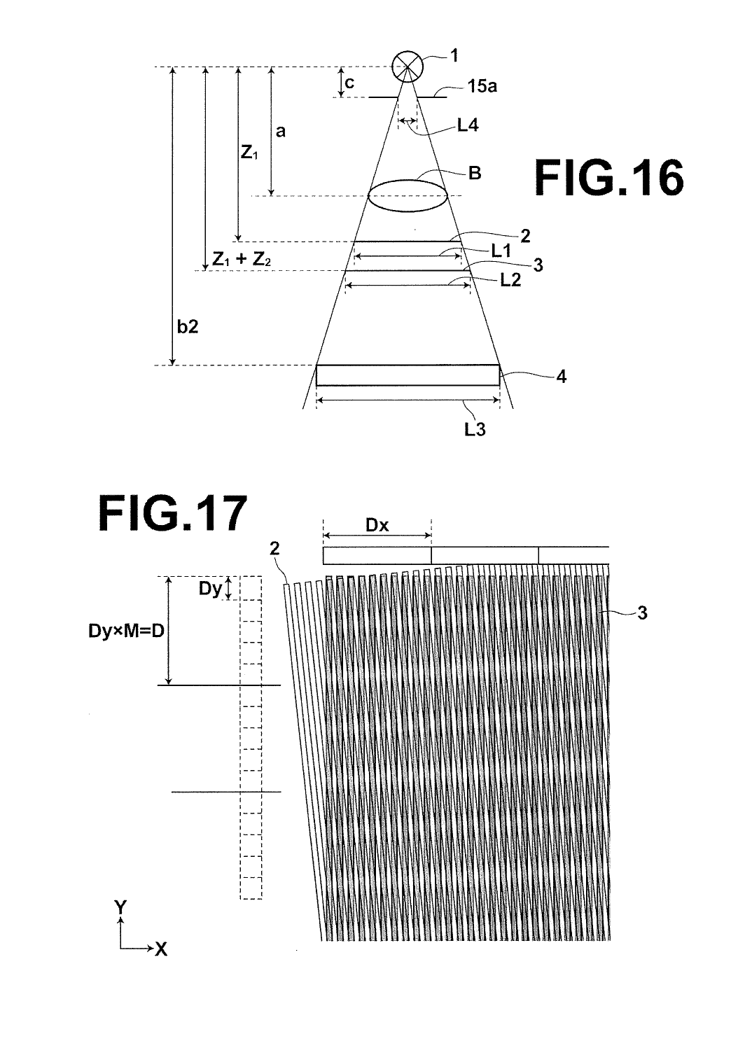

between the radiation field size L4 and the size L3 of the radiographic image detector 4. Therefore, the moving mechanism control unit 60a sets the distance b between the focal spot of the radiation source 1 and the detection plane of the radiographic image detector 4 at b2, as shown in FIG. 16 for example, based on the distance c between the focal spot of the radiation source 1 and the radiation field diaphragm 15a. Then, the second acceptable magnification factor candidate Mac′ is calculated based on Expression below:

Mac′=b2/a=(c×L3)/(a×L4).

Then, the control unit 60 may compare the first acceptable magnification factor candidate Mac with the second acceptable magnification factor candidate Mac′, and may set the larger one of the magnification factor candidates as a final acceptable magnification factor. The operations carried out after the acceptable magnification factor has been set are the same as those described in the above-described embodiment.

It should be noted that the radiation field size obtained by the radiation field size obtaining unit 67 may be directly set and inputted by the operator via the input unit 50, or an image taken in advance may be displayed on the monitor 40 and a region of interest, which is desired to be imaged by magnification imaging, may be set within the image and a radiation field size corresponding to the region of interest may be obtained by the radiation field size obtaining unit 67. The region of interest may be specified by the operator or may automatically be set based on predetermined conditions. It is assumed here that the correspondence relationship between the region of interest and the radiation field size is set in advance. The image taken in advance may, for example, be an ordinary mammographic image which is taken before the magnification imaging at a lower magnification or a wider field of view.

Although the distance Z₂ from the first grating 2 to the second grating 3 is the Talbot interference distance in the radiographic phase-contrast imaging apparatus of the above-described embodiment, this is not intended to limit the invention. The first grating 2 may be adapted to project the incident radiation without diffracting the radiation. In this case, similar projection images passed through the first grating 2 can be obtained at any position behind the first grating 2, and therefore the distance Z₂ from the first grating 2 to the second grating 3 can be set irrespectively of the Talbot interference distance.

Specifically, both the first grating 2 and the second grating 3 are formed as absorption type (amplitude modulation type) gratings to geometrically project the radiation passed through the slits irrespectively of the Talbot interference effect. In more detail, by setting values of the interval d₁ of the first grating 2 and the interval d₂ of the second grating 3 sufficiently greater than the effective wavelength of the radiation applied from the radiation source 1, the most part of the applied radiation can travel straight and pass through the slits without being diffracted by the slits. For example, in the case where tungsten is used as the target of the radiation source and the tube voltage is 50 kV, the effective wavelength of the radiation is about 0.4 Å. In this case, the most part of the radiation is geometrically projected without being diffracted by the slits by setting the interval d₁ of the first grating 2 and the interval d₂ of the second grating 3 on the order of 1 μm to 10 μm.

It should be noted that the relationship between the grating pitch P₁ of the first grating 2 and the grating pitch P₂ of the second grating 3 is the same as that in the first embodiment.

In the radiographic phase-contrast imaging apparatus having the above-described configuration, the distance Z₂ between the first grating 2 and the second grating 3 can be set at a value that is shorter than the minimum Talbot interference distance when m=1 in Expression (6) above. That is, the value of the distance Z₂ is set in a range satisfying Expression (18) below:

$${Z}_{2} < \frac{{P}_{1} {P}_{2}}{λ} \qquad ( 18 )$$

In order to generate a high-contrast periodic pattern image, it is preferred that the members 22 of the first grating 2 and the members 32 of the second grating 3 completely shield (absorb) the radiation. However, even when the above-described material (such as gold or platinum) having high radiation absorption is used, no small part of the radiation is transmitted without being absorbed. Therefore, in order to increase the radiation shielding property, the thicknesses h₁ and h₂ of the members 22 and 32 may be made as thick as possible. The members 22 and 32 may shield 90% or more of the radiation applied thereto. For example, if the tube voltage of the radiation source 1 is 50 kV, the thicknesses h₁ and h₂ may be 100 μm more when the members 22 and 32 are made of gold (Au).

However, similarly to the above-described embodiment, there is the problem of so-called vignetting of the radiation, and thus there is a limitation on the thicknesses h₁ and h₂ of the members 22 of the first grating 2 and the members 32 of the second grating 3.

According to the radiographic phase-contrast imaging apparatus having the above-described configuration, the distance Z₂ between the first grating 2 and the second grating 3 can be made shorter than the Talbot interference distance. In this case, the imaging apparatus can be made thinner than the radiographic phase-contrast imaging apparatus of the above-described embodiment, which have to ensure a certain Talbot interference distance.

Although the plurality of fringe image signals for generating the phase contrast image are obtained by carrying out the plurality of imaging operations with shifting (translating) the second grating 3 by the scanning mechanism 5 in the grid unit 16 in the above-described embodiment, there is another method where the plurality of fringe image signals can be obtained in a single imaging operation without shifting the second grating as in the above-described method.

Specifically, as shown in FIG. 17, the first grating 2 and the second grating 3 are positioned such that the direction in which the self image G1 of the first grating 2 extends is inclined relative to the direction in which the second grating 3 extends, such that the relationship as shown in FIG. 17 between a main-pixel size Dx in the main-scanning direction (the X-direction in FIG. 5) and a sub-pixel size Dy in the sub-scanning direction of each pixel of the image signal detected by the radiographic image detector 4 is achieved with respect to the thus positioned first grating 2 and third grating 3.

For example, in a case where the radiographic image detector is a radiographic image detector of a so-called optical reading system, which has a number of linear electrodes, where the image signal is read out by being scanned with a linear reading light source extending in a direction orthogonal to the direction in which the linear electrodes extend, the main-pixel size Dx is determined by the arrangement pitch of the linear electrodes of the radiographic image detector. In this case, the sub-pixel size Dy is determined by the width of linear reading light in a direction in which the linear electrodes extend, which is applied to the radiographic image detector. In a case where a radiographic image detector of a so-called TFT reading system or a radiographic image detector using a CMOS sensor is used, the main-pixel size Dx is determined by the arrangement pitch of a pixel circuit in the arrangement direction of data electrodes, from which the image signal is read out, and the sub-pixel size Dy is determined by the arrangement pitch of the pixel circuit in the arrangement direction of gate electrodes, from which gate voltages are outputted.

Assuming that the number of the fringe images used to generate the phase contrast image is M, the self image G1 of the first grating 2 is inclined relative to the second grating 3 such that Dy×M=D, where “Dy×M” represents M sub-pixel sizes Dy and “D” represents an image resolution in the sub-scanning direction of the phase contrast image.

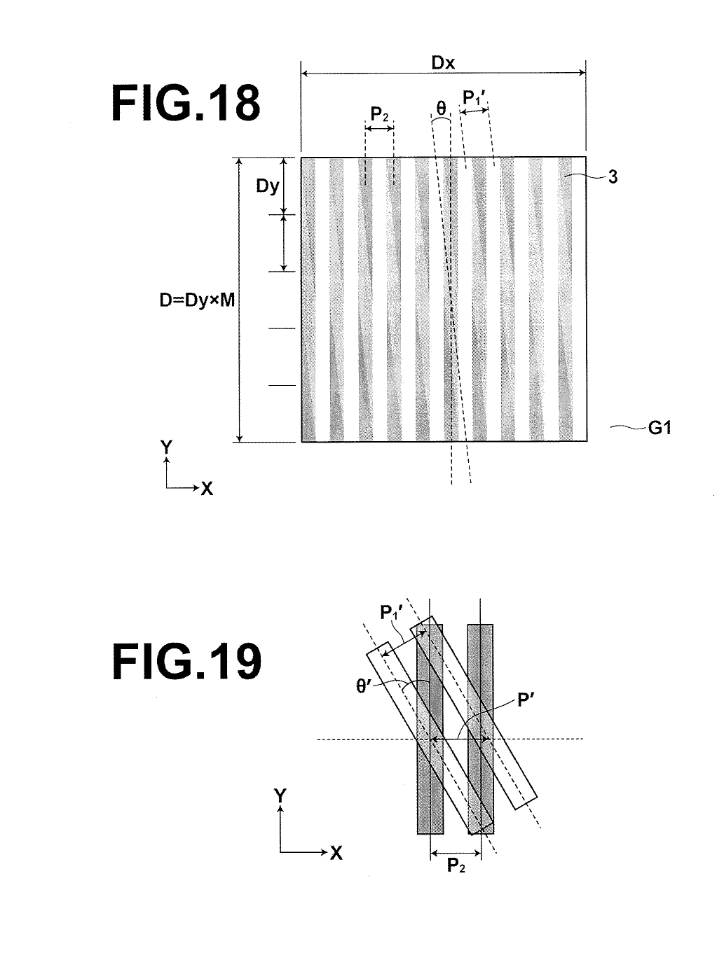

Specifically, as shown in FIG. 18, assuming that the pitch of the second grating 3 and the pitch of the self image G1 of the first grating 2 formed by the first grating 2 at the position of the second grating 3 is p₁′, a rotational angle in the X-Y plane of the self image G1 of the first grating 2 relative to the second grating 3 is θ, and the image resolution in the sub-scanning direction of the phase contrast image is D (=Dy×M), then, the self image G1 of the first grating 2 deviates from the phase of the second grating 3 by an amount of n period(s) over the length of the image resolution D in the sub-scanning direction when the rotational angle θ is set to satisfy Expression (19) below (it should be noted that FIG. 17 shows a case where M=5 and n=1):

$$θ = arc tan \{ n \times \frac{{P}_{1}^{′}}{D} \} \qquad ( 19 )$$

where n is an integer other than 0 and a multiple of M.

Therefore, an image signal corresponding to a fraction of an intensity modulation for n period(s) of the self image G1 of the first grating 2 divided by M can be detected by each pixel having the size Dx×Dy, which corresponds to the image resolution D in the sub-scanning direction of the phase contrast image divided by M. Since n=1 in the example shown in FIG. 18, the self image G1 of the first grating 2 deviates from the phase of the second grating 3 by one period over the length of the image resolution D in the sub-scanning direction. Simply put, the range of the self image G1 of the first grating 2 passing through the second grating 3 for one period varies across the length of the image resolution D in the sub-scanning direction.

Then, since M=5 in this example, an image signal corresponding to a fraction of an intensity modulation for one period of the self image G1 of the first grating 2 divided by 5 can be detected by each pixel having the size Dx×Dy. That is, image signals of five different fringe images can be detected by the five pixels having the size Dx×Dy.

It should be noted that, since Dx=50 μm, Dy=10 μm and M=5 in this embodiment, as described above, the image resolution Dx in the main-scanning direction of the phase contrast image is the same as the image resolution D=Dy×M in the sub-scanning direction. However, it is not necessary that the image resolution Dx in the main-scanning direction and the image resolution D in the sub-scanning direction are the same, and they may have any main/sub ratio.

Although M=5 in this embodiment, M may be 3 or more, other than 5. Although n=1 in the above description, n may be any integer other than 0. That is, if n is a negative integer, the direction of the rotation is opposite from that in the above-described example. Further, n may be an integer other than ±1 to provide an intensity modulation for n periods. However, if n is a multiple of M, the same pattern is generated by the self image G1 of the first grating 2 and the phase of the second grating 3 among one set of M pixels having the size Dy in the sub-scanning direction, and it is impossible to obtain the M different fringe images. Therefore, n is other than a multiple of M.

Adjustment of the rotational angle θ of the self image G1 of the first grating 2 relative to the second grating 3 can be achieved, for example, by fixing a relative rotational angle between the radiographic image detector 4 and the second grating 3, and then rotating the first grating 2.

For example, assuming that p₁′=5 μm, D=50 μm and n=1 in Expression (19) above, a rotational angle θ is set to be about 5.7°. Then, an actual rotational angle θ′ of the self image G1 of the first grating 2 relative to the second grating 3 can be detected, for example, by a pitch of moire formed between the self image G1 of the first grating and the second grating 3.

Specifically, as shown in FIG. 19, assuming that the actual rotational angle is θ′ and an apparent pitch of the self image G1 in the X-direction after the rotation is P′, an observed moire pitch Pm is expressed as follows:

1/Pm=|1/P′−1/P₁′|.

Therefore, the actual rotational angle θ′ can be found by assigning:

P′=P₁′/cos θ

to the above Expression. It should be noted that the moire pitch Pm may be found based on the image signals detected by the radiographic image detector 4.

Then, the actual rotational angle θ′ is compared with the rotational angle θ to be set which is deviated from Expression (19), and the rotational angle of the first grating 2 may be adjusted automatically or manually by an amount corresponding to the difference between the actual rotational angle θ′ and the rotational angle θ to be set.

In the radiographic phase-contrast imaging apparatus having the above-described configuration, the image signals of a whole single frame read out from the radiographic image detector 4 are stored in the phase contrast image generation unit 61, and then, image signals of five different fringe images are obtained based on the stored image signals.

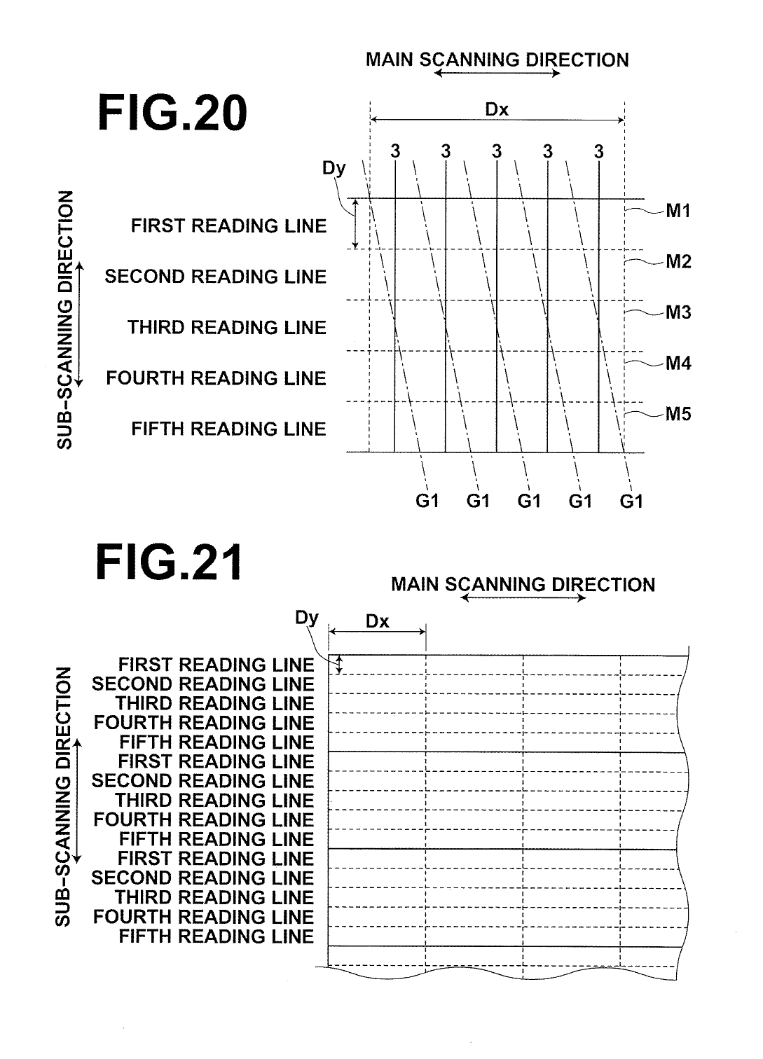

Specifically, in the case, as shown in FIG. 18, where the self image G1 of the first grating 2 is inclined relative to the second grating 3 such that the image resolution D in the sub-scanning direction of the phase contrast image is divided by 5 to detect image signals corresponding to fractions of the intensity modulation for one period of the self image G1 of the first grating 2 divided by 5, an image signal read out from the first reading line is obtained as a first fringe image signal M1, an image signal read out from the second reading line is obtained as a second fringe image signal M2, an image signal read out from the third reading line is obtained as a third fringe image signal M3, an image signal read out from the fourth reading line is obtained as a fourth fringe image signal M4 and an image signal read out from the fifth reading line is obtained as a fifth fringe image signal M5, as shown in FIG. 20. It should be noted that each of the first to fifth reading lines shown in FIG. 20 corresponds to the sub-pixel size Dy shown in FIG. 17. Although FIG. 20 only shows a reading range of Dx×(Dy×5), the first to fifth fringe image signals are obtained in the same manner from the remaining reading range. Namely, as shown in FIG. 21, image signals of each pixel line group including pixel lines (reading lines) of every five pixels in the sub-scanning direction are obtained to obtain a single fringe image signal of a single frame. More specifically, image signals of the pixel line group of the first reading lines are obtained to obtain a first fringe image signal of a single frame, image signals of the pixel line group of the second reading lines are obtained to obtain a second fringe image signal of the single frame, image signals of the pixel line group of the third reading lines are obtained to obtain a third fringe image signal of the single frame, image signals of the pixel line group of the fourth reading lines are obtained to obtain a fourth fringe image signal of the single frame, and image signals of the pixel line group of the fifth reading lines are obtained to obtain a fifth fringe image signal of the single frame.

In this manner, the different first to fifth fringe image signals are obtained, and the phase contrast image generation unit 61 generates the phase contrast image based on the first to fifth fringe image signals. Although, in the above description, the phase contrast image is generated with using the plurality of fringe image signals which are obtained by obtaining the image signals of the different pixel line groups from the single image, which is taken in the state where the first grating 2 and the second grating 3 are positioned such that the direction in which the self image G1 of the first grating 2 extends and the direction in which the second grating 3 extends are inclined relative to each other, as shown in FIG. 17, there is another usable method, which involves applying a Fourier transform to the single image taken as described above to generate the phase contrast image, without generating the fringe image signals based on the single image taken as described above.

Specifically, first, the Fourier transform is applied to the single image taken in the above-described state where the first grating 2 and the second grating 3 are positioned such that the direction in which the self image G1 of the first grating 2 extends and the direction in which the second grating 3 extends are inclined relative to each other, thereby separating absorption information and phase information which are influenced by the subject B contained in the image from each other.

Then, only the phase information influenced by the subject B in a frequency space is extracted and moved to the center (origin) position of the frequency space, and an inverse Fourier transform is applied to the extracted phase information. Then, the resulting imaginary part is divided by the real part for each pixel, and an arc tangent function (arctan (imaginary part/real part)) of the result of the division is calculated to find the refraction angle φ in Expression (17). Thus, the differential of the phase shift distribution in Expression (13), i.e., the differential phase image can be obtained.

Although the single image taken in the state where the first grating 2 and the second grating 3 are positioned such that the direction in which the self image G1 of the first grating 2 extends and the direction in which the second grating 3 extends are inclined relative to each other is used in the above-described method for generating the phase contrast image using the Fourier transform, this is not intended to limit the invention. For example, at least one image where moire, which is formed by superposing the self image G1 of the first grating 2 on the second grating 3, is detected may be used in the above-described method using the Fourier transform.

Now, the arrangement and operation of the above-described radiographic image detector of the optical reading system are described.

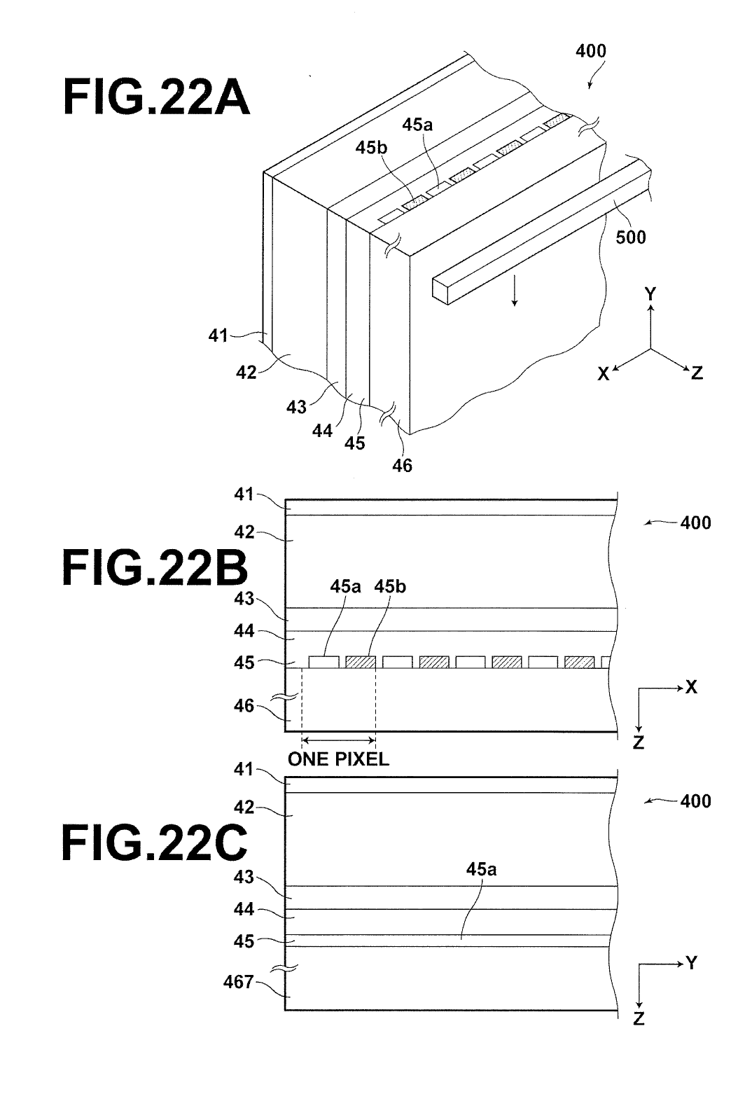

In FIG. 22, a perspective view of a radiographic image detector 400 of an optical reading system is shown at “A”, a sectional view of the radiographic image detector shown at A taken along the XZ-plane is shown at “B”, and a sectional view of the radiographic image detector shown at A taken along the YZ-plane is shown at “C”.

As shown at A to C in FIG. 22, the radiographic image detector 400 includes: a first electrode layer 41 that transmits radiation; a recording photoconductive layer 42 that generates electric charges when exposed to the radiation transmitted through the first electrode layer 41; an electric charge storing layer 43 that acts as an insulator against the electric charges of one of the polarities generated at the recording photoconductive layer 42 and acts as an conductor for the electric charges of the other of the polarities generated at the recording photoconductive layer 42; a reading photoconductive layer 44 that generates electric charges when exposed to reading light; and a second electrode layer 45, which are formed in layers on a glass substrate 46 in this order, where the second electrode layer 45 is formed on the glass substrate 46.

The first electrode layer 41 is made of a material that transmits radiation. Examples of the usable material may include MESA film (SnO₂), ITO (Indium Tin Oxide), IZO (Indium Zinc Oxide), and IDIXO (Idemitsu Indium X-metal Oxide, available from Idemitsu Kosan Co., Ltd.) which is an amorphous light-transmitting oxide film. The thickness of the first electrode layer 41 is in the range from 50 to 200 nm. As other examples, Al or Au with a thickness of 100 nm may be used.

The recording photoconductive layer 42 may be made of a material that generates electric charges when exposed to radiation. In view of relatively high quantum efficiency with respect to radiation and high dark resistance, a material mainly composed of a-Se is used. An appropriate thickness of the recording photoconductive layer 42 is in the range from 10 μm to 1500 μm. For mammography, in particular, the thickness of the recording photoconductive layer 42 may be in the range from 150 μm to 250 μm. For general imaging, the thickness of the recording photoconductive layer 42 may be in the range from 500 μm to 1200 μm.

The electric charge storing layer 43 is a film that insulates the electric charges of a polarity intended to be stored. Examples of the material forming the electric charge storing layer 43 may include: polymers, such as an acrylic organic resin, polyimide, BCB, PVA, acryl, polyethylene, polycarbonate and polyetherimide; sulfides, such as As₂S₃, Sb₂S₃ and ZnS; oxides; and fluorides. Optionally, the material forming the electric charge storing layer 43 insulates the electric charges of a polarity intended to be stored and conducts the electric charges of the opposite polarity. Further optionally, such a material that a product of mobility×life varies by as much as three digits or more depending on the polarity of the electric charges may be used.

Examples of compounds may include: As₂Se₃; As₂Se₃ doped with 500 ppm to 20000 ppm of Cl, Br or I; As₂(SeₓTe₁₋ₓ)₃ (where 0.5<x<1) provided by substituting about 50% of Se of As₂Se₃ with Te; a compound provided by substituting about 50% of Se of As₂Se₃ with S; AsₓSe_{y} (where x+y=100, 34≦x≦46) provided by changing the As concentration of As₂Se₃ by about ±15%; and an amorphous Se—Te where the Te content is 5 to 30 wt %.

In the case where such a material containing a chalcogenide element is used, the thickness of the electric charge storing layer may be in the range from 0.4 μm to 3.0 μm, or may optionally be in the range from 0.5 μm to 2.0 μm. The above-described electric charge storing layer may be formed at once or by stacking two or more layers.

The material forming the electric charge storing layer 43 may have a permittivity in the range from a half to twice of the permittivity of the recording photoconductive layer 42 and the reading photoconductive layer 44 so that a straight line of electric force formed between the first electrode layer 41 and the second electrode layer 45 is maintained.

The reading photoconductive layer 44 is made of a material that becomes conductive when exposed to the reading light. Examples of the material forming the reading photoconductive layer 44 may include photoconductive materials mainly composed of at least one of a-Se, Se—Te, Se—As—Te, metal-free phthalocyanine, metal phthalocyanine, MgPc (Magnesium phthalocyanine), VoPc (phase II of Vanadyl phthalocyanine), CuPc (Copper phthalocyanine), etc. The thickness of the reading photoconductive layer 44 may be in the range from about 5 to about 20 μm.

The second electrode layer 45 includes a plurality of transparent linear electrodes 45a that transmit the reading light and a plurality of light-shielding linear electrodes 45b that shield the reading light. The transparent linear electrodes 45a and light-shielding linear electrodes 45b continuously extend from one end to the other end of an imaging area of the radiographic image detector 400 in straight lines. As shown at A and B in FIG. 22, the transparent linear electrodes 45a and the light-shielding linear electrodes 45b are alternately arranged at a predetermined interval.

The transparent linear electrodes 45a are made of a material that transmits the reading light and is electrically conductive. For example, similarly to the first electrode layer 41, the transparent linear electrodes 45a may be made of ITO, IZO or IDIXO. The thickness of the transparent linear electrodes 45a is in the range from about 100 to about 200 nm.

The light-shielding linear electrodes 45b are made of a material that shields the reading light and is electrically conductive. For example, the light-shielding linear electrodes 45b may be formed by a combination of the above-described transparent electrically conducting material and a color filter. The thickness of the transparent electrically conducting material is in the range from about 100 to about 200 nm.

In the radiographic image detector 400, one set of the transparent linear electrode 45a and the light-shielding linear electrode 45b adjacent to each other is used to read out an image signal, as described in detail later. Namely, as shown at B in FIG. 22, one set of the transparent linear electrode 45a and the light-shielding linear electrode 45b reads out an image signal of one pixel. For example, the transparent linear electrodes 45a and the light-shielding linear electrodes 45b may be arranged such that one pixel is substantially 50 μm.

As shown at A in FIG. 22, the radiographic image detector 400 also includes a linear reading light source 500, which extends in a direction (the X-direction) orthogonal to the direction along which the transparent linear electrodes 45a and the light-shielding linear electrodes 45b extend. The linear reading light source 500 is formed by a light source, such as LED (Light Emitting Diode) or LD (Laser Diode), and a predetermined optical system, and is adapted to apply linear reading light having a width of substantially 10 μm in the Y-direction to the radiographic image detector 400. The linear reading light source 500 is moved by a predetermined moving mechanism (not shown) relative to the Y-direction. As the linear reading light source 500 is moved in this manner, the linear reading light emitted from the linear reading light source 500 scans the radiographic image detector 400 to read out the image signals.

Next, operation of the radiographic image detector 400 having the above-described configuration is described.

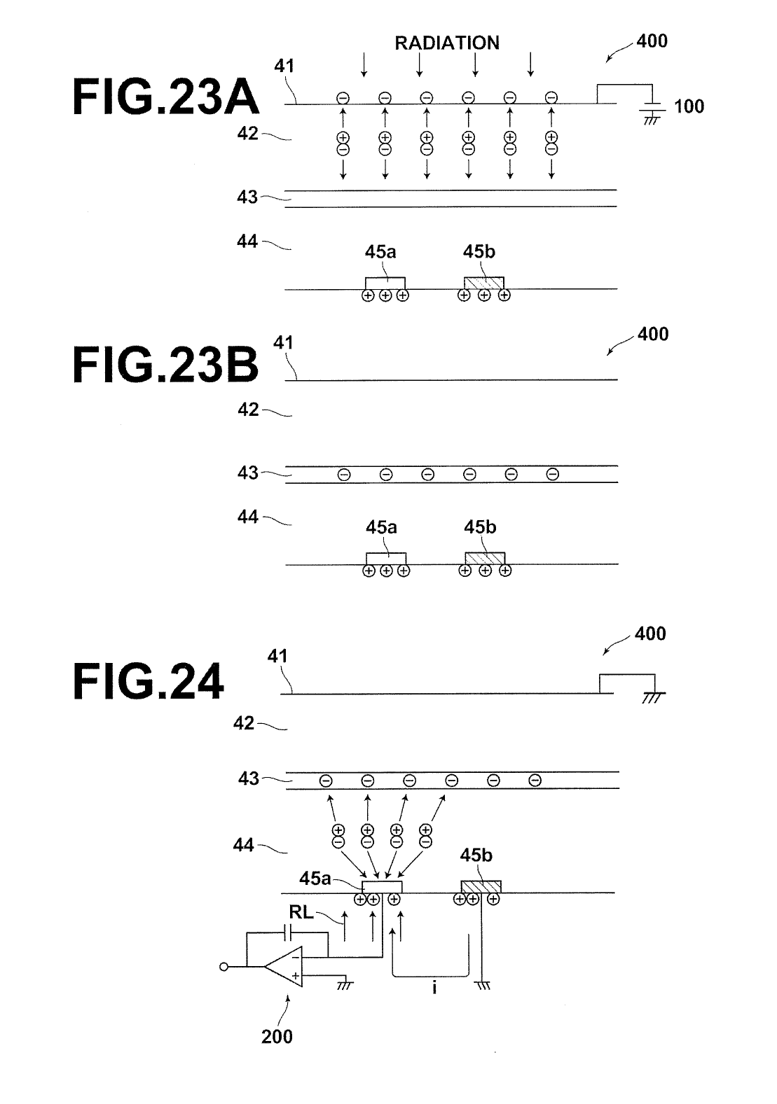

First, as shown at “A” in FIG. 23, in a state where a high-voltage power supply 100 applies a negative voltage to the first electrode layer 41 of the radiographic image detector 400, the radiation with the intensity thereof modulated by superposing the self image G1 of the first grating 2 on the second grating 3 is applied to the radiographic image detector 400 from the first electrode layer 41 side thereof.

Then, the radiation applied to the radiographic image detector 400 is transmitted through the first electrode layer 41 to be applied to the recording photoconductive layer 42. The application of the radiation causes generation of electric charge pairs at the recording photoconductive layer 42. Among the generated electric charge pairs, positive electric charges are combined with negative electric charges charged in the first electrode layer 41 and disappear, and negative electric charges are stored as latent image electric charges in the electric charge storing layer 43 (see “B” in FIG. 23).

Then, as shown in FIG. 24, in a state where the first electrode layer 41 is grounded, linear reading light RL emitted from the linear reading light source 500 is applied to the radiographic image detector 400 from the second electrode layer 45 side thereof. The reading light RL is transmitted through the transparent linear electrodes 45a to be applied to the reading photoconductive layer 44. Positive electric charges generated at the reading photoconductive layer 44 by the application of the reading light RL are combined with the latent image electric charges stored in the electric charge storing layer 43. Negative electric charges generated at the reading photoconductive layer 44 by the application of the reading light RL are combined with positive electric charges charged in the light-shielding linear electrodes 45b via a charge amplifier 200 connected to the transparent linear electrodes 45a.

When the negative electric charges generated at the reading photoconductive layer 44 are combined with the positive electric charges charged in the light-shielding linear electrodes 45b, electric currents flow to the charge amplifier 200, and the electric currents are integrated and detected as an image signal.

As the linear reading light source 500 is moved along the sub-scanning direction (the Y-direction), the linear reading light RL scans the radiographic image detector 400. Then, for each reading line exposed to the linear reading light RL, the image signals are sequentially detected by the above-described operation, and the detected image signals of each reading line are sequentially inputted to and stored in the phase contrast image generation unit 61.

In this manner, the entire surface of the radiographic image detector 400 is scanned by the reading light RL, and the image signals of a whole single frame are stored in the phase contrast image generation unit 61.

Although the example where the radiographic phase-contrast imaging apparatus of the invention is applied to the breast imaging and display system has been described in the above-described embodiment, this is not intended to limit the invention. The radiographic phase-contrast imaging apparatus of the invention is also applicable to a radiographic imaging system that images a subject in the upright position, a radiographic imaging system that images a subject in the supine position, a radiographic imaging system that can image a subject in the standing position and the supine position, a radiographic imaging system that carries out long-length imaging, etc.

The present invention is also applicable to a radiographic phase-contrast CT apparatus that obtains a three-dimensional image, a stereo imaging apparatus that obtains a stereo image which can be stereoscopically viewed, etc.

The above-described embodiment provides an image which has conventionally been difficult to be depicted by obtaining a phase contrast image. Since conventional X-ray radiodiagnostics are based on absorption images, referencing an absorption image together with a corresponding phase contrast image can help image interpretation. For example, it is effective that a part of a body site which cannot be depicted in the absorption image is supplemented with image information of the phase contrast image by superposing the absorption image and the phase contrast image one on the other through suitable processing, such as weighting, tone processing or frequency processing.

However, if the absorption image is taken separately from the phase contrast image, it is difficult to successfully superpose the absorption image and the phase contrast image one on the other due to positional change of the subject body part between an imaging operation to take the phase contrast image and an imaging operation to take the absorption image, and the number of imaging operation increases, which increases the burden on the subject. Further, in recent years, small-angle scattering images are drawing attention, besides the phase contrast images and the absorption images. The small-angle scattering image can depict tissue characteristics attributed to a minute structure in a subject tissue, and is expected to be a depiction method for new imaging diagnosis in the fields of cancers and cardiovascular diseases, for example.

To this end, the computer 30 may further include an absorption image generation unit for generating an absorption image from the fringe images, which are obtained for generating the phase contrast image, and a small-angle scattering image generation unit for generating a small-angle scattering image from the fringe images.

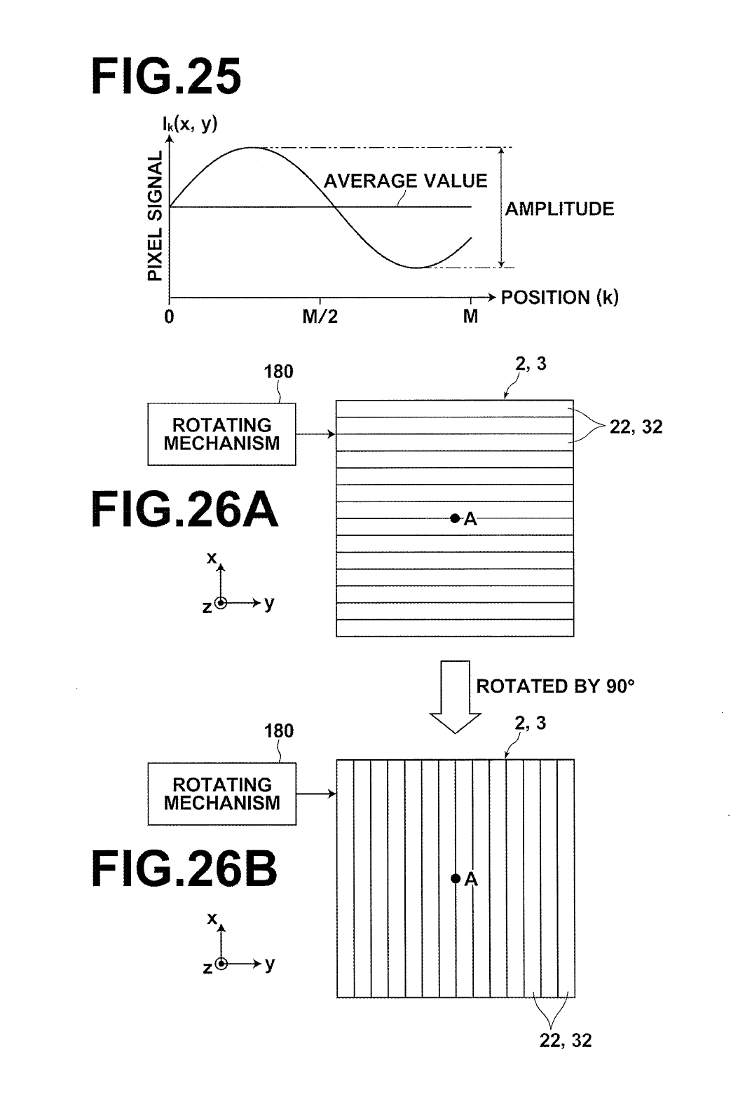

The absorption image generation unit generates the absorption image by averaging pixel signals Ik(x,y), which are obtained for each pixel, with respect to k, as shown in FIG. 25, to calculate an average value for each pixel to form an image. The calculation of the average value may be achieved by simply averaging the pixel signals Ik(x,y) with respect to k. However, since a large error occurs when M is small, the pixel signals Ik(x,y) may be fitted by a sinusoidal wave, and then an average value of the fitted sinusoidal wave may be calculated. Besides a sinusoidal wave, a square wave form or a triangular wave form may be used.

The method used to generate the absorption image is not limited to one using the average value, and any other value corresponding to the average value, such as an addition value calculated by adding up the pixel signals Ik(x,y) with respect to k, may be used.

The small-angle scattering image generation unit generates the small-angle scattering image by calculating an amplitude value of the pixel signals Ik(x,y) obtained for each pixel to form an image. The calculation of the amplitude value may be achieved by calculating a difference between the maximum value and the minimum value of the pixel signals Ik(x,y). However, since a large error occurs when M is small, the pixel signals Ik(x,y) may be fitted by a sinusoidal wave, and then an amplitude value of the fitted sinusoidal wave may be calculated. The method used to generate the small-angle scattering image is not limited to one using the amplitude value, and any other value corresponding to a variation relative to the average, such as a variance value or a standard deviation, may be used.

Further, the phase contrast image is based on refracted components of the X-ray in the direction (the X-direction) in which the members 22 and 32 of the first and second gratings 2 and 3 are periodically arranged, and does not reflect refracted components in the direction (the Y-direction) in which the members 22 and 32 extend. That is, a contour of a body site along a direction intersecting with the X-direction (the Y-direction if the direction is orthogonal to the X-direction) is depicted in a phase contrast image based on the refracted components in the X-direction, and a contour of the body site along the X-direction, which dose not intersect with the X-direction, is not depicted in the phase contrast image in the X-direction. That is, there is a body site which cannot be depicted depending on the shape and orientation of the body site, which is a subject B. For example, it is believed that, when the direction of a plane of loading of an articular cartilage of the knee, or the like, is aligned with the Y-direction among the X- and Y-directions in the plane of the grating, a contour of the body site in the vicinity of the plane of loading (the YZ-plane) almost along the Y-direction is sufficiently depicted, but tissues (such as tendon and ligament) around the cartilage extending almost along the X-direction and intersecting with the plane of loading are depicted insufficiently. Although it is possible to retake the image of the insufficiently depicted body site with moving the subject H, this increases the burden on the subject H and the operator, and it is difficult to ensure positional repeatability between the image taken first and the image retaken next.

In order to address this problem, another preferred example is shown in FIG. 26, where a rotating mechanism 180 for rotating the first and second gratings 2 and 3 is provided in the grid unit 16. The rotating mechanism 180 rotates the first and second gratings 2 and 3 by an arbitrary angle from a first orientation, as shown at “a” in FIG. 26, around an imaginary line (the optical axis A of the X-ray) orthogonal to the center of the plane of the first and second gratings 2 and 3 into a second orientation as shown at “b” in FIG. 26, so that phase contrast images with respect to the first orientation and in the second orientation are generated.

In this manner, the above-described problem of positional repeatability can be solved. It should be noted that, although the orientation shown at “a” in FIG. 26 is the first orientation of the first and second gratings 2 and 3 where the members 32 of the second grating 3 extend along the Y-direction, and the orientation shown at “b” in FIG. 26 is the second orientation of the first and second gratings 2 and 3 where the first and second gratings 2 and 3 are rotated by 90° from the state shown at “a” in FIG. 26 such that the members 32 of the second grating 3 extend along the X-direction, the rotational angle of the first and second gratings 2 and 3 may be any angle as long as the relative inclination between the first grating 2 and the second grating 3 is maintained. Further, the rotating operation may be performed twice or more to generate the phase contrast images with respect to a third orientation, a fourth orientation, and the like, in addition to the first orientation and the second orientation.

Still further, rather than rotating the first and second gratings 2 and 3 which are one-dimensional gratings, as described above, the first and second gratings 2 and 3 may be formed as two-dimensional gratings, where the members 22 and 32 extend in two-dimensional directions, respectively.

Comparing this configuration with the configuration where the one-dimensional gratings are rotated, this configuration provides phase contrast images corresponding to first and second directions in a single imaging operation, and thus the phase contrast images are not influenced by body motion of the subject and vibration of the apparatus between imaging operations and good positional repeatability is ensured between the phase contrast images corresponding to the first and second directions. Further, by eliminating the rotating mechanism, simplification and cost reduction of the apparatus can be achieved.

What is claimed is:

1. A radiographic phase-contrast imaging method for use with a radiographic phase-contrast imaging apparatus including: a first grating having a periodically arranged grating structure and allowing radiation emitted from a radiation source to pass therethrough to form a first periodic pattern image; a second grating having a periodically arranged grating structure including areas transmitting the first periodic pattern image formed by the first grating and areas shielding the first periodic pattern image to form a second periodic pattern image; a radiographic image detector to detect the second periodic pattern image formed by the second grating; and a moving mechanism to move the radiographic image detector in directions of relative movement toward and away from the radiation source, thereby achieving magnification imaging, the method comprising:
calculating an acceptable magnification factor based on size information of the radiographic image detector and size information of at least one of the first and second gratings, the acceptable magnification factor ensuring the radiation transmitted through the first and second gratings to be received within the radiographic image detector.

2. A radiographic phase-contrast imaging apparatus comprising:
a first grating having a periodically arranged grating structure and allowing radiation emitted from a radiation source to pass therethrough to form a first periodic pattern image;
a second grating having a periodically arranged grating structure including areas transmitting the first periodic pattern image formed by the first grating and areas shielding the first periodic pattern image to form a second periodic pattern image;
a radiographic image detector to detect the second periodic pattern image formed by the second grating;
a moving mechanism to move the radiographic image detector in directions of relative movement toward and away from the radiation source, thereby achieving magnification imaging; and
an acceptable magnification factor calculation unit to calculate an acceptable magnification factor based on size information of the radiographic image detector and size information of at least one of the first and second gratings, the acceptable magnification factor ensuring the radiation transmitted through the first and second gratings to be received within the radiographic image detector.

3. The radiographic phase-contrast imaging apparatus as claimed in claim 2, wherein the radiographic image detector is replaceable.

4. The radiographic phase-contrast imaging apparatus as claimed in claim 3, further comprising
a detector size information obtaining unit to obtain the size information of the radiographic image detector,
wherein the acceptable magnification factor calculation unit calculates the acceptable magnification factor based on the size information obtained by the detector size information obtaining unit.

5. The radiographic phase-contrast imaging apparatus as claimed in claim 2, further comprising
a magnification factor obtaining unit to receive and obtain an input of a magnification factor for the magnification imaging,
wherein the moving mechanism moves the radiographic image detector according to the magnification factor obtained by the magnification factor obtaining unit.

6. The radiographic phase-contrast imaging apparatus as claimed in claim 5, further comprising
a moving mechanism control unit to control the moving mechanism to move the radiographic image detector by a distance according to the magnification factor obtained by the magnification factor obtaining unit only in a case where the magnification factor is within a range of the acceptable magnification factor.

7. The radiographic phase-contrast imaging apparatus as claimed in claim 5, further comprising
an imaging control unit to permit the magnification imaging to be carried out according to the magnification factor obtained by the magnification factor obtaining unit only in a case where the magnification factor is within a range of the acceptable magnification factor.

8. The radiographic phase-contrast imaging apparatus as claimed in claim 2, wherein at least one of the first and second gratings is replaceable.

9. The radiographic phase-contrast imaging apparatus as claimed in claim 8, further comprising
a grid size obtaining unit to obtain the size information of at least one of the first and second gratings,
wherein the acceptable magnification factor calculation unit calculates the acceptable magnification factor based on the size information of at least one of the first and second gratings obtained by the grid size obtaining unit and the size information of the radiographic image detector.

10. The radiographic phase-contrast imaging apparatus as claimed in claim 5, further comprising
a magnification factor warning unit to warn, if the magnification factor obtained by the magnification factor obtaining unit is greater than the acceptable magnification factor, to that effect.

11. The radiographic phase-contrast imaging apparatus as claimed in claim 2, further comprising
an acceptable magnification factor output unit to output the acceptable magnification factor.

12. The radiographic phase-contrast imaging apparatus as claimed in claim 2, further comprising:
a radiation field diaphragm to confine an exposure range of the radiation emitted from the radiation source, the radiation field diaphragm being disposed between the radiation source and the first grating; and
an acceptable radiation field size calculation unit to calculate an acceptable radiation field size of the radiation field diaphragm based on the acceptable magnification factor.

13. The radiographic phase-contrast imaging apparatus as claimed in claim 12, further comprising:
a radiation field size obtaining unit to receive and obtain an input of a radiation field size of the radiation field diaphragm; and
a radiation field size warning unit to warn, if the radiation field size obtained by the radiation field size obtaining unit is greater than the acceptable radiation field size, to that effect.

14. The radiographic phase-contrast imaging apparatus as claimed in claim 12, further comprising
an acceptable radiation field size output unit to output the acceptable radiation field size.

15. The radiographic phase-contrast imaging apparatus as claimed in claim 12, further comprising
a radiation field size limiter unit to limit a settable radiation field size of the radiation field diaphragm based on the acceptable radiation field size.

16. The radiographic phase-contrast imaging apparatus as claimed in claim 2, further comprising:
a radiation field diaphragm to confine an exposure range of the radiation emitted from the radiation source, the radiation field diaphragm being disposed between the radiation source and the first grating; and
an acceptable magnification factor candidate obtaining unit to obtain, as a first acceptable magnification factor candidate, the acceptable magnification factor calculated based on the size information of the radiographic image detector and the size information of the first and second gratings, and to calculate a second acceptable magnification factor candidate based on the size information of the radiographic image detector and the radiation field size of the radiation field diaphragm.

17. The radiographic phase-contrast imaging apparatus as claimed in claim 16, further comprising
a radiation field size obtaining unit to receive and obtain an input of the radiation field size of the radiation field diaphragm.

18. The radiographic phase-contrast imaging apparatus as claimed in claim 16, further comprising
a radiation field size obtaining unit to obtain the radiation field size of the radiation field diaphragm based on a range set on an image obtained in advance.

19. The radiographic phase-contrast imaging apparatus as claimed in claim 16, wherein
the acceptable magnification factor calculation unit compares the first acceptable magnification factor candidate with the second acceptable magnification factor candidate and determines larger one of the acceptable magnification factor candidates as a final acceptable magnification factor.

20. The radiographic phase-contrast imaging apparatus as claimed in claim 19, wherein
the moving mechanism control unit controls the moving mechanism to move the radiographic image detector by a distance according to an inputted magnification factor only in a case where the inputted magnification factor is within a range of the final acceptable magnification factor.

21. The radiographic phase-contrast imaging apparatus as claimed in claim 19, further comprising
an imaging control unit to permit the magnification imaging to be carried out according to an inputted magnification factor only in a case where the inputted magnification factor is within a range of the final acceptable magnification factor.
